(19) United States
(12) Patent Application Publication
(10) Pub. No.: US 2026/0235493 A1
(43) Pub. Date: Aug. 13, 2026

(54) FLOW CYTOMETER, BIOLOGICAL SAMPLE ANALYSIS SYSTEM, AND OPTICAL DETECTION APPARATUS

(71) Applicant: Sony Group Corporation, Tokyo (JP)

(72) Inventors: Shingo Imanishi, Kanagawa (JP); Motohiro Furuki, Tokyo (JP); Takamichi Yamakoshi, Tokyo (JP); Takeshi Yamasaki, Kanagawa (JP); Satoshi Nagae, Tokyo (JP)

(73) Assignee: Sony Group Corporation, Tokyo (JP)

(21) Appl. No.: 19/161,170

(22) PCT Filed: Mar. 8, 2024
(86) PCT No.: PCT/JP2024/008947

§ 371 Date: Aug. 29, 2025

(30) Foreign Application Priority Data
Mar. 9, 2023 (JP) 2023-036453
Jan. 26, 2024 (JP) 2024-010329

(51) Int. Cl. G01N 15/14; G01N 15/10; G01N 15/1429; G01N 15/1434

(52) U.S. Cl. CPC G01N 15/147; G01N 15/1429; G01N 15/1434; G01N 2015/1006; G01N 2015/144

(57) ABSTRACT

Provided is a flow cytometer including an optical detection component that detects emission light emitted by a particle flowing in a flow path generated by application of light to the particle flowing in the flow path, in which the optical detection apparatus includes multiple light detector arrays in each of which light detector elements are lined up in a respective row, and the multiple light detector arrays are arranged at predetermined intervals along a direction intersecting with an arraying direction substantially parallel to the respective rows of the light detector elements of each of the light detector arrays.

### CROSS REFERENCE TO RELATED APPLICATIONS

This application claims the benefit of Japanese Priority Patent Application JP 2023-036453 filed Mar. 9, 2023, the entire contents of which are incorporated herein by reference.

### TECHNICAL FIELD

The present technology relates to a flow cytometer, a biological sample analysis system, and an optical detection apparatus. More particularly, the present disclosure relates to a flow cytometer and a biological sample analysis system that perform analysis based on light generated by light application to a bioparticle and an optical detection apparatus that is used in the flow cytometer or the biological sample analysis system.

### BACKGROUND ART

There is sometimes performed labeling of a particle cluster of, for example, cells, microorganisms, and liposomes with a fluorescent dye, irradiation of particles of the particle cluster with laser light, and measurement of an intensity and/or a pattern of fluorescence generated from the fluorescent dye excited by the irradiation with the laser light, to measure a characteristic of the particles. As an example of a particle analysis apparatus that performs such measurement as just described, a flow cytometer can be mentioned.

A biological sample analysis apparatus such as a flow cytometer irradiates particles which flow in a lined up relation in a row in a flow path with laser light (excitation light) of a specific wavelength and detect fluorescence and/or scattered light generated from each particle, to analyze the multiple particles one by one. Further, a desired bioparticle is sometimes preparatively isolated in reference to a result of the analysis. An apparatus having the preparative isolation function is sometimes called a cell sorter.

Such a biological sample analysis device as described above includes an optical detection apparatus for the analysis. Several technologies relating to the optical detection apparatus have been disclosed. For example, PTL 1 specified below discloses a fluorescence signal acquisition apparatus including multiple light sources that irradiate a measurement target including multiple phosphors with multiple rays of excitation light modulated with carriers having frequencies different from each other, multiple fluorescence detection sections that detect multiple rays of fluorescence light generated in response to the multiple rays of excitation light, a multi band-pass optical filter that is positioned in a preceding stage of the multiple fluorescence detection sections to branch the multiple rays of fluorescence light to multiple optical paths and passes therethrough rays of fluorescence light from multiple phosphors having wavelengths that are not consecutive, and a synchronous detection section that synchronously detects detection signals individually detected by the fluorescence detection sections to separate rays of fluorescent light corresponding to the multiple phosphors (claim 1). As the fluorescence detection section, a photomultiplier tube is mentioned (claim 11).

### CITATION LIST

### Patent Literature

PTL 1: Japanese Patent Laid-Open No. 2015-145829

### SUMMARY

### Technical Problem

A biological sample analysis system such as a flow cytometer detects weak fluorescence light or scattered light generated from a cell. In order to detect such weak light as just described, an optical detection apparatus having high sensitivity is used. As the optical detection apparatus, for example, a photomultiplier tube (also called PMT) is used as described above.

The biological sample analysis system that performs optical detection by such an optical detection apparatus as described above frequently has an increased size. This matters especially in a case where the biological sample analysis system is configured such that a bioparticle is irradiated with light at multiple light irradiation spots. For example, in such a biological sample analysis apparatus as just described, multiple optical detection units are provided in order to individually detect rays of light from the multiple light irradiation spots. This gives rise to increase of the number of optical detection apparatuses and increase and complexity of the configuration of an optical system for introducing light to each optical detection apparatus and gives rise also to increase in size of the biological sample analysis system.

Downsizing of the biological sample analysis system is demanded. Downsizing the biological sample analysis system makes it easier for its user to use it and also makes it possible for its user to utilize the experiment environment more widely. Therefore, it is desirable to downsize the biological sample analysis system described above.

### Solution to Problem

According to an embodiment of the present disclosure, there is provided a flow cytometer including an optical detection apparatus that detects light generated by light application to a bioparticle flowing in a flow path, in which the optical detection apparatus includes multiple light detector arrays in each of which light detector elements are lined up in a row, and the multiple light detector arrays are arranged at predetermined intervals along a direction intersecting with an arraying direction of the light detector arrays.

The multiple light detector arrays may be arranged in such a manner as to correspond to a flow direction of the flow path.

Each of the multiple light detector arrays may be a light detector array in which photomultiplier tube elements are lined up in a row, a light detector array in which avalanche photodiode elements are lined up in a row, or a light detector array in which photomultiplier tube elements are lined up in a row or a light detector array in which avalanche photodiode elements are lined up in a row.

Each of the multiple light detector arrays may be a light detector array in which photomultiplier tube elements are lined up in a row.

Each of the photomultiplier tube elements may be a photomultiplier tube element that includes a dynode including a semiconductor element or a photomultiplier tube element that includes multiple stages of dynodes.

The optical detection apparatus may be a multi-pixel photon counter.

The flow cytometer may include a light irradiation section that irradiates a bioparticle flowing in the flow path with light at multiple light irradiation positions along a flow direction of the flow path.

The multiple light irradiation positions may each be irradiated with rays of light having wavelengths different from each other.

The flow cytometer may be configured to detect rays of light originating from light application at two or more positions among the multiple light irradiation positions, by one optical detection apparatus.

The multiple light detector arrays may be configured such that gains thereof are allowed to be adjusted independently of each other.

Multiple light detector units included in the light detector arrays may be configured such that gains thereof c are allowed to an be adjusted independently of each other.

One or more of the multiple light detector arrays may be configured such that positions thereof in a direction intersecting with the arraying direction of the light detector arrays are allowed to be changed independently of each other.

One or more of the multiple light detector arrays may be configured such that positions thereof in the arraying direction of the light detector arrays are allowed to be changed independently of each other.

The optical detection apparatus may further include a microlens array, and the microlens array may be provided such that each of lenses configuring the microlens array exists on each of the light detector elements of the optical detection apparatus.

The flow cytometer may include a propagation optical path along which light generated by the light application is to be propagated to the optical detection apparatus, and the propagation optical path may include one or more optical fibers.

The flow cytometer may further include a light irradiation section that irradiates a bioparticle flowing in the flow path with light at multiple light irradiation positions along the flow direction of the flow path, and a propagation optical path along which light generated by light application by the light irradiation section is to be propagated to the optical detection apparatus.

The propagation optical path may include multiple optical fiber cores optical path, and the multiple optical fiber core optical paths may be arranged in such a manner as to correspond to intervals between the multiple light irradiation positions at a light entering side terminal end thereof.

The flow cytometer may further include a light irradiation section that irradiates a bioparticle flowing in the flow path with light at multiple light irradiation positions along the flow direction of the flow path, and a propagation optical path along which light generated by light irradiation by the light irradiation section is to be propagated to the optical detection apparatus.

The propagation optical path may include multiple optical fiber core optical paths, and the multiple optical fiber core optical paths may be arranged in such a manner as to correspond to intervals between the light detector arrays at a light outgoing side terminal end thereof.

The flow cytometer may further include a propagation optical path along which light generated by light application to a bioparticle flowing in the flow path is to be propagated to the optical detection apparatus, and a field diaphragm may be interposed in the propagation optical path.

At least one of the multiple light detector arrays may include 10 or more light detector units.

Multiple light detector elements included in the optical detection apparatus may be configured to be capable of detecting light independently of each other in time.

Further, according to another embodiment of the present disclosure, there is also provided a biological sample analysis system including an optical detection apparatus that detects light generated by light application to a bioparticle flowing in a flow path, in which the optical detection apparatus includes multiple light detector arrays in each of which light detector elements are lined up in a row, and the multiple light detector arrays are arranged at predetermined intervals along a direction intersecting with an arraying direction of the light detector arrays.

Further, according to a further embodiment of the present disclosure, there is also provided an optical detection apparatus including multiple light detector arrays in each of which light detector elements are lined up in a row, in which the multiple light detector arrays are arranged at predetermined intervals along a direction intersecting with an arraying direction of the light detector arrays, and are used to detect light generated by light application to a bioparticle flowing in a flow path.

The optical detection apparatus may be used in combination with a light irradiation section that irradiates the bioparticle with light at multiple light irradiation positions along a flow direction of the flow path.

The optical detection apparatus may be used in combination with a spectral optical system that spectrally disperses multiple rays of light generated by light application at the multiple light irradiation positions.

Two or more light detector arrays among the multiple light detector arrays may include at least one light detector element having a detection wavelength range that is the same between the two or more light detector arrays.

### BRIEF DESCRIPTION OF DRAWINGS

FIG. 1 is a view depicting an example of a configuration of a flow cytometer.

FIG. 2 is a view depicting an example of a configuration of a flow cytometer according to an embodiment of the present disclosure.

FIG. 3A is a view depicting an example of a configuration of an optical detection apparatus.

FIG. 3B is a view depicting the example of the configuration of the optical detection apparatus.

FIG. 4 is a view depicting an example of a configuration of a hybrid photodetector.

FIG. 5 is a schematic view illustrating a light irradiation position by a light irradiation section.

FIG. 6 is a schematic view illustrating a position change of a light detector array.

FIG. 7 is a schematic view illustrating another position change of a light detector array.

FIG. 8 is a schematic view illustrating a further position change of a light detector array.

FIG. 9 is a schematic view depicting a modification of the optical detection apparatus.

FIG. 10 is a schematic view depicting another modification of the optical detection apparatus.

FIG. 11 is a view depicting an example of arrangement of a microlens array.

FIG. 12 is a view depicting an example of a configuration of another flow cytometer according to an embodiment of the present disclosure.

FIG. 13 is a view depicting an example of a schematic configuration of an optical fiber bundle.

FIG. 14 is a schematic view of optical paths for light to an optical detection apparatus designed by a spectral optical system.

FIG. 15 is a schematic view depicting an entrance surface in a case where light guided by the spectral optical system enters the optical detection apparatus.

FIG. 16 is a schematic view depicting a modification of the optical detection apparatus.

FIG. 17 is a view depicting an example of a configuration of a further flow cytometer according to an embodiment of the present disclosure.

FIG. 18 is a view schematically depicting a general configuration of a biological sample analysis apparatus.

FIG. 19A is a schematic view of an example of the optical fiber bundle.

FIG. 19B is a schematic view of another example of the optical fiber bundle.

FIG. 19C is a schematic view of an example of an optical fiber.

FIG. 19D is a schematic view of another example of the optical fiber.

FIG. 19E is a schematic view of a further example of the optical fiber.

FIG. 19F is a schematic view of a still further example of the optical fiber.

FIG. 19G is a schematic view of a yet further example of the optical fiber.

FIG. 19H is a schematic view of a yet further example of the optical fiber.

### DESCRIPTION OF EMBODIMENTS

In the following, preferred modes for carrying out the present disclosure are described. It is to be noted that embodiments described below indicate representative embodiments of the present disclosure, and the scope of the present disclosure shall not be restricted only to the embodiments. It is to be noted that the description of the present disclosure is given in the following order.
1. First Embodiment (flow cytometer)
(1) Example of basic configuration
(2) Example of configuration of optical detection apparatus
(3) Relation with light irradiation section
(4) Modification of optical detection apparatus
(4-1) Change of position
(4-2) Modification of light detector array
(4-3) Microlens array
(5) Utilization of optical fiber
(6) Other examples of configuration (use of multiple optical detection apparatuses)
(7) Embodiment including no objective lens
(8) Example of configuration of flow cytometer
2. Second Embodiment (biological sample analysis system)
3. Third Embodiment (optical detection apparatus)

### 1. FIRST EMBODIMENT (FLOW CYTOMETER)

### (1) Example of Basic Configuration

As described hereinabove, downsizing is demanded for a biological sample analysis system such as a flow cytometer. As one of main components of a biological sample analysis system, a detection section including an optical detection apparatus that detects light generated from a bioparticle can be mentioned. The detection section sometimes causes increase of the size of the biological sample analysis system. Therefore, it is desirable to reduce the space to be occupied by the detection section.

As an optical detection apparatus, for example, an image sensor of a charge coupled device (CCD), a complementary metal oxide semiconductor (CMOS), or the like can be mentioned. However, since the reading out method of such image sensors as just mentioned is that of a frame mode, it is difficult to detect rays of light of pixels independently of each other. Further, the image sensors do not have the sensitivity suitable for detecting weak light such as fluorescence generated from a bioparticle.

As a light detector having sensitivity higher than that of an image sensor, a photomultiplier tube and an avalanche photodiode (APD) can be mentioned. The inventors have found out that a specific optical detection apparatus having such a light detector as just described is suitable for use with a biological sample analysis system such as a flow cytometer, for example.

In particular, according to an embodiment of the present disclosure, there is provided a biological sample analysis system that includes an optical detection apparatus that detects light generated by light application to a bioparticle flowing in a flow path and in which the optical detection apparatus includes multiple light detector arrays in each of which light detector elements are lined up in a row and the multiple light detector arrays are arranged at predetermined intervals along a direction intersecting with the arraying direction of the light detector arrays.

In one embodiment, the biological sample analysis system may be a flow cytometer. The optical detection apparatus is suitable to detect weak light such as fluorescence and/or scattered light generated by light application to a bioparticle (for example, a cell, a liposome, or the like) flowing in the flow path and is suitable specifically for a case in which the bioparticle is irradiated with light at multiple positions.

Use of the optical detection apparatus contributes to downsizing of the biological sample analysis system and especially to downsizing of the detection section.

Further, the optical detection apparatus can be configured such that the light detector elements or the light detector arrays allow gains thereof to be adjusted independently of each other. The signal strength of a fluorescent signal or the like sometimes differs much depending upon the wavelength. In such a case as just described, rays of light of individual wavelengths can be kept in a dynamic range by gain adjustment as described above.

Further, the multiple light detector elements included in the optical detection apparatus may be configured to be capable of detecting light independently of each other in time. This makes it possible for the light detector elements to detect light independently of each other on a real time basis.

In the following, the present disclosure is described in more detail with reference to the drawings.

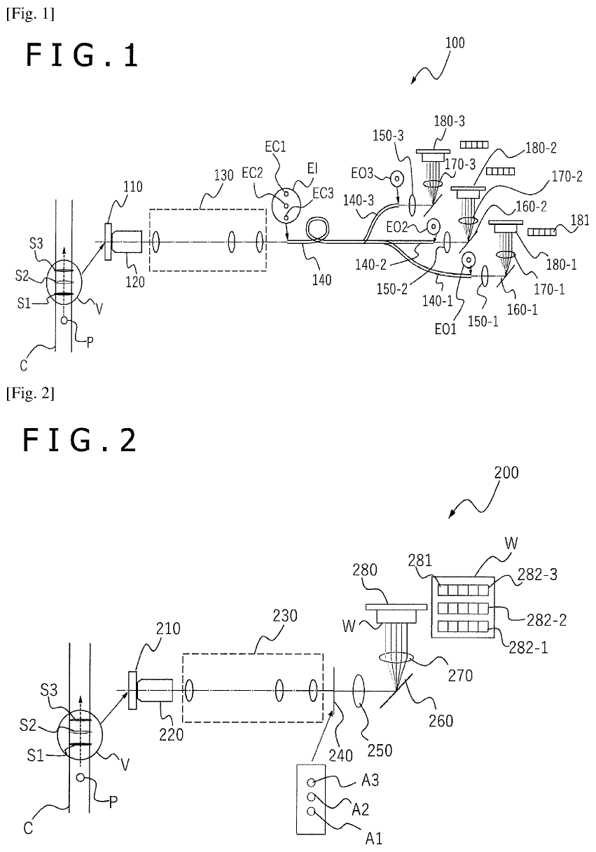

It is considered that a detection section used in a flow cytometer is configured, for example, in such a manner as described below with reference to FIG. 1. FIG. 1 is a schematic diagram of the detection section.

A flow cytometer 100 depicted in FIG. 1 is configured to irradiate a bioparticle P flowing in a flow path C provided in a flow cell 110 with light. In FIG. 1, the bioparticle P flows in a direction indicated by a broken line arrow mark.

A light irradiation section (not depicted) of the flow cytometer is configured to irradiate multiple positions with light. In FIG. 1, three light irradiation positions S1 to S3 are depicted. In particular, the light irradiation section is configured to irradiate each of the three light irradiation positions with light (especially, laser light) and includes, for example, three laser sources. The laser sources emit rays of light of wavelengths different from each other.

When the bioparticle P flows in the flow path C, the bioparticle passes the light irradiation positions. Upon such passage, the particle is irradiated with light at each of the light irradiation positions, and light is generated from the particle by the irradiation. The generated light passes an objective lens 120, passes a flow path side light guide optical system 130, and then arrives at an optical fiber bundle 140.

The objective lens 120 is configured such that the three light irradiation positions S1 to S3 are present in a visual field V thereof. The flow path side light guide optical system 130 is a light guide optical system that allows light outgoing from the objective lens 120 to arrive at the optical fiber bundle that is a propagation optical path. For the elements mentioned, configurations known in the relevant technical field may be adopted, and a person skilled in the art can suitably configure them.

The optical fiber bundle 140 is a bundle having the number of optical fiber cores corresponding to the number of optical detection apparatuses 180 (180-1, 180-2, and 180-3) hereinafter described or may be a bundle having the number of optical fiber cores equal to or greater than the number of optical detection apparatuses 180. The bundle may include multiple optical fibers bundled with each other, the multiple optical fibers each including, for example, one core, a clad surrounding the core, and a covering layer surrounding the clad. In this case, the optical fiber bundle 140 may include the number of optical fibers equal to or greater than the number of optical detection apparatuses.

Alternatively, the bundle may include multiple core-clad sets each including a single core and a clad surrounding the core and being bundled with each other and a single covering layer that covers the bundled core-clad sets. In this case, the optical fiber bundle 140 may include the number of core-clad sets equal to or greater than the number of optical detection apparatuses.

Otherwise, in place of the optical fiber bundle, an optical fiber in which a single clad includes multiple cores may be used. In this case, the number of cores included in the fiber may be equal to or greater than the number of optical detection apparatuses. At a flow path side end EI of the optical fiber bundle 140, the position of the optical fiber cores is fixed. In FIG. 1, the optical fiber bundle is configured such that the three cores EC1, EC2, and EC3 are arranged at predetermined intervals. The interval between the cores corresponds to the interval between the light irradiation positions S1 to S3 and may be, for example, an interval calculated by multiplying the interval between the light irradiation positions S1 to S3 by a predetermined magnifying power. Light entering the flow path side end EI advances toward the optical detection apparatus side ends EO1 to EO3.

The optical fiber bundle 140 is unbundled midway and branched to the three optical fibers. The number of optical fibers after being branched corresponds to the number of optical detection apparatuses. The flow cytometer in FIG. 1 includes three optical detection apparatuses, and in a corresponding relation with this, the optical fiber bundle 140 is branched to three optical fibers.

Light emitted from the optical fiber 140-1 after being branched passes a detector side light guide optical system 150-1 and arrives at a spectral optical system 160-1.

Although the detector side light guide optical system 150-1 is depicted as one lens for simplified illustration in FIG. 1, it is apparent that the configuration of the detector side light guide optical system is not restricted to this. It is sufficient if the detector side light guide optical system is configured to allow light outgoing from the optical fiber 140-1 to be introduced to a desired position of the spectral optical system 160-1, and this configuration may be designed suitably by a person skilled in the art. For example, the detector side light guide optical system may include one or more lenses and/or one or more mirrors.

It is to be noted that, in the present specification, the detector side light guide optical systems 150-1, 150-2, and 150-3 are sometimes denoted collectively by a reference sign 150.

Although the spectral optical system 160-1 is depicted, in FIG. 1, as a reflection type diffraction grating, it is apparent that the configuration of the spectral optical system is not restricted to this. It is sufficient if the spectral optical system has an optical characteristic of spectrally dispersing light for each wavelength and hence is a spectroscope, and the configuration thereof may be designed suitably by a person skilled in the art. Since the spectral optical system spectrally disperses light for each wavelength, optical data for each wavelength is obtained. For example, the spectral optical system is not restricted to a reflection type diffraction grating and may be a transmission type diffraction grating or may be a prism. The prism may be one prism or may be a combination of multiple prisms.

It is to be noted that, in the present specification, the spectral optical systems 160-1, 160-2, and 160-3 are sometimes denoted collectively by a reference sign 160.

Rays of light spectrally dispersed for individual wavelengths by the spectral optical system arrive at a telecentric condensing lens 170-1. The telecentric condensing lens parallelizes the optical axes of the spectrally dispersed rays of light and emits them toward the optical detection apparatus 180-1. Although the telecentric condensing lens is indicated as one lens in FIG. 1, it is apparent to those skilled in the art that the configuration of the telecentric condensing lens is not restricted to this. It is sufficient if the telecentric condensing lens is configured to parallelize the spectrally dispersed rays of light, and the configuration thereof may be designed suitably by a person skilled in the art. For example, although the telecentric condensing lens may be one lens, it may otherwise include multiple lenses.

It is to be noted that, in the present specification, the telecentric condensing lenses 170-1, 170-2, and 170-3 are sometimes denoted collectively by a reference sign 170.

The optical detection apparatus 180-1 is configured such that multiple light detector elements 181 are lined up in a row as depicted in FIG. 1. Although, in FIG. 1, five light detector elements are lined up in a row, it is apparent to those skilled in the art that the number of such elements lined up in a row is not restricted to five. Each of the light detector elements may be, for example, a PMT. The light detector element is used as a fluorescence channel. A photon entering from an entrance window of each PMT is converted into a photoelectron at a photoelectric surface and is outputted as an electric signal after being amplified. The outputted electric signal is used as optical data for bioparticle analysis by an information processing section hereinafter described.

Also light emitted from the optical fiber 140-2 passes through the detector side light guide optical system 150-2, the diffraction grating 160-2, and the telecentric condensing lens 170-2 and is detected by the optical detection apparatus 180-2 as described hereinabove in connection with the light outgoing from the optical fiber 140-1.

Also light emitted from the optical fiber 140-3 passes through the detector side light guide optical system 150-3, the diffraction grating 160-3, and the telecentric condensing lens 170-3 and is detected by the optical detection apparatus 180-3 as described hereinabove in connection with the light from the optical fiber 140-1.

Three laser sources included in the light irradiation section are allocated individually to the three optical detection apparatuses 180-1 to 180-3. The optical detection apparatus 180-1 detects light generated by light application to a bioparticle at the light irradiation position S1 by one laser source. The optical detection apparatuses 180-2 and 180-3 detect light generated by light application to the bioparticle at the light irradiation position S2 by another laser source and light generated by light application to the bioparticle at the light irradiation position S3 by a further laser source, respectively. In such a manner, the laser sources and the optical detection apparatuses have a one-by-one relation.

In order to perform optical detection by the optical detection apparatus, various optical elements are provided in a one-by-one relation in such a manner as depicted in FIG. 1. For example, in order to allow light to arrive at each of the optical detection apparatuses 180-1 to 180-3, a set of a detector side light guide optical system, a spectral optical system, and a telecentric condensing lens is provided on an optical path between an optical fiber and an optical detection apparatus. In particular, also the number of sets of a light guide optical system, a diffraction grating, and a condensing lens increases according to the number of optical detection apparatuses. Thus, the size of the flow cytometer is likely to have an increased size.

The flow cytometer according to an embodiment of the present disclosure includes a specific optical detection apparatus. The specific optical detection apparatus includes multiple light detector arrays in each of which light detector elements are lined up in a row, and the multiple light detector arrays are arranged at predetermined intervals along a direction intersecting with the arraying direction of the light detector arrays. Consequently, the configuration of the optical systems to be incorporated in the flow cytometer can be made compact. Specifically, the number of optical parts of the light guide optical systems, the spectral optical systems, the telecentric condensing lenses, and so forth can be reduced, and this contributes to downsizing of the flow cytometer.

An example of a schematic configuration of the flow cytometer according to an embodiment of the present disclosure is depicted in FIG. 2. A flow cytometer 200 depicted in FIG. 2 is configured to irradiate a bioparticle P flowing in a flow path provided in a flow cell 210 with light. The flow cytometer includes an objective lens 220 and a flow path side light guide optical system 230. The objective lens 220 is configured such that three light irradiation positions S1 to S3 are present in the visual field V thereof. The flow cell 210, the objective lens 220, and the flow path side light guide optical system 230 may be configured in a manner similar to that of the flow cell 110, the objective lens 120, and the flow path side light guide optical system 130 described hereinabove with reference to FIG. 1, respectively, and the description of them similarly applies to the flow cytometer 200.

Light emitted from the flow path side light guide optical system 230 passes through a field diaphragm 240, a detector side light guide optical system 250, a spectral optical system 260, and a telecentric condensing lens 270 and arrives at an optical detection apparatus 280.

The field diaphragm 240 may be configured to be capable of restricting an observation target region, and, for example, field diaphragms A1 to A3 corresponding to respective rays of light generated by light application at the light irradiation positions S1 to S3 may be provided. This makes it possible to prevent leaking in of unnecessary stray light.

Light having passed through the field diaphragm 240 arrives at the detector side light guide optical system 250. The detector side light guide optical system 250 is configured to introduce the light to the spectral optical system 260. In regard to optical parts that configure the detector side light guide optical system 250, the description of the detector side light guide optical systems 150 given hereinabove applies. The detector side light guide optical system 250 may include, for example, one or more collimate lenses that collimate the light and/or one or more lenses for enlarging or contracting an image of the light. The configuration of the detector side light guide optical system 250 may be designed suitably by a person skilled in the art.

As depicted in FIG. 2, three rays of light generated by light irradiation at the three light irradiation positions pass the same detector side light guide optical system 250. In such a manner, the flow cytometer according to an embodiment of the present disclosure may be configured such that one detector side light guide optical system is used as an optical path for multiple rays of light generated by light irradiation at multiple light irradiation positions.

Light departing from the detector side light guide optical system 250 arrives at the spectral optical system 260. The spectral optical system 260 spectrally disperses the light and allows the light to arrive at the telecentric condensing lens 270. The light is spectrally dispersed for individual wavelengths by the spectral optical system. In regard to optical parts that configure the spectral optical system, the description of the spectral optical systems 160 given hereinabove applies. The spectral optical system may be, for example, a diffraction grating (a transmission type diffraction grating or a reflection type diffraction grating) or may be a prism as described hereinabove in connection with the spectral optical systems 160.

In a case where a prism is used as the spectral optical system, although known materials that can be used for a prism such a glass material can be used suitably as the material configuring the prism, it is preferable to use, among such materials, a material having high internal transmittance. By using a material having high internal transmittance, it can be expected that the loss of the light amount of light entering the prism is reduced and the light is effectively guided to the optical detection apparatus. Especially, using a material having high internal transmittance on the short wave side makes it possible to reduce the influence of attenuation of light that differs for each wavelength. Further, if the surface of the prism is coated by AR coating (Anti reflection coating: Anti Reflecting Coating), it is possible to reduce the attenuation amount of light at the time of spectral dispersion.

Further, using a material having high dispersibility as the material for configuring the prism makes it possible to suitably separate light entering the prism for each wavelength. This makes it possible to reduce the number of prisms to be used in an optical path.

In a case where a prism is used as the spectral optical system, adjusting the magnitude of a vertical angle or the like according to an object of use of the prism makes it possible to use a prism designed in any shape.

As depicted in FIG. 2, the three rays of light generated by light application at the three light irradiation positions all pass the same spectral optical system 260 and are spectrally dispersed by the spectral optical system. In such a manner, the flow cytometer according to an embodiment of the present disclosure may be configured such that one spectral optical system is used as an optical path for multiple rays of light generated by light application at multiple light irradiation positions.

The rays of light spectrally dispersed by the spectral optical system 260 arrive at the telecentric condensing lens 270. The telecentric condensing lens 270 parallelizes the spectrally dispersed rays of light and allows them to arrive at the optical detection apparatus 280. The telecentric condensing lens may be configured in such a manner as described hereinabove in connection with the telecentric condensing lens 170.

As depicted in FIG. 2, the three rays of light generated by light application at the three light irradiation positions all pass, after passing through the spectral optical system 260, the same telecentric condensing lens 270 such that the advancing directions of the spectrally dispersed rays of light are parallelized by the telecentric condensing lens, and the parallelized rays of light arrive at the optical detection apparatus. In such a manner, the flow cytometer according to an embodiment of the present disclosure may be configured such that one telecentric condensing lens is used as an optical path for multiple rays of light generated by light application at multiple light irradiation positions.

Also a configuration of the light detector element in a case of being viewed from a light entering surface W of the optical detection apparatus 280 is depicted in FIG. 2. As indicated in a region of reference sign W in FIG. 2, the optical detection apparatus 280 includes three light detector arrays 282-1 to 282-3 in each of which multiple light detector elements 281 are lined up in a row.

In FIG. 2, although five light detector elements are lined up in a row in each of the light detector arrays, it is apparent to those skilled in the art that the number of such elements lined up in a row is not restricted to five. The number of such elements may be selected suitably, for example, according to the desired number of fluorescence channels by a person skilled in the art.

Further, although the optical detection apparatus 280 includes, in FIG. 2, three light detector arrays, the number of light detector arrays included in one optical detection apparatus is not restricted to three. The number of light detector arrays may be changed, for example, according to the number of light irradiation positions. For example, the optical detection apparatus may include the number of light detector arrays equal to the number of the light irradiation positions. In several embodiments, the optical detection apparatus may include light detector arrays in a number smaller or greater than the number of the light irradiation positions.

The light detector element is used as a fluorescence channel. A photon incident to the light detector element is converted into a photoelectron at the photoelectric surface and is outputted as an electric signal after being amplified. The outputted electric signal is used as optical data by the information processing section hereinafter described and is used, for example, for bioparticle analysis.

The optical detection apparatus 280 depicted in FIG. 2 includes three light detector arrays 280-1 to 280-3, each of which includes light detector elements lined up in a row. The light detector array 280-1 is allocated in such a manner as to detect light generated by light application at the light irradiation position S1; the light detector array 280-2 is allocated in such a manner as to detect light generated by light application at the light irradiation position S2; and the light detector array 280-3 is allocated in such a manner as to detect light generated by light application at the light irradiation position S3. As depicted in FIG. 2, the light irradiation positions S1 to S3 are lined up in a row along the flow direction, and also the light detector arrays 280-1 to 280-3 are lined up in a row in a corresponding relation with the arrangement order of the light irradiation positions S1 to S3. In other words, the light detector arrays 280-1 to 280-3 are also lined up in a row in such a manner as to correspond to the flow direction of a bioparticle.

It can also be regarded that the three light detector arrays are arranged at predetermined intervals along a direction intersecting with the arraying direction of the light detector arrays (specifically, in an orthogonal direction).

In such a manner, the optical detection apparatus according to an embodiment of the present disclosure includes multiple light detector arrays in each of which light detector elements are lined up in a row, and the multiple light detector arrays are arranged at predetermined intervals along a direction intersecting with the arraying direction of the light detector arrays.

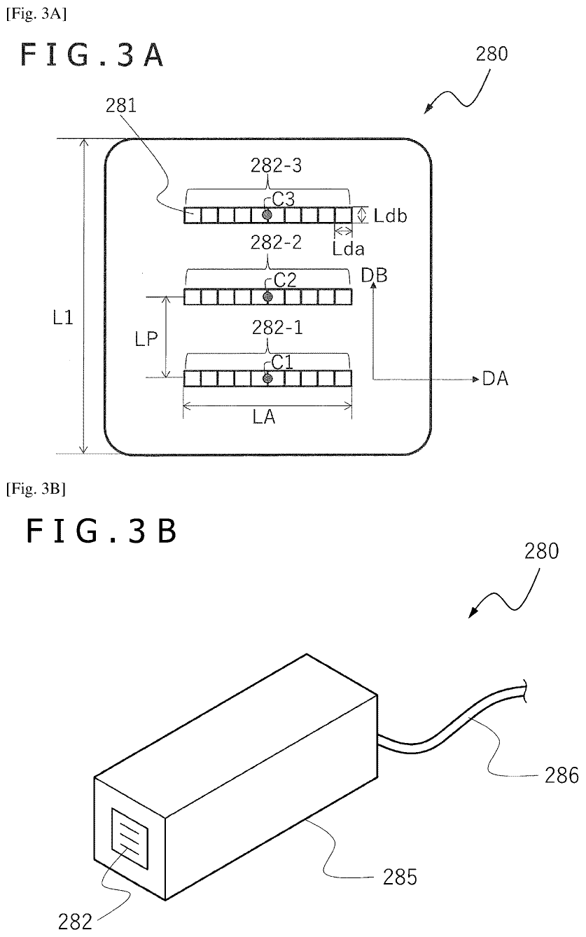

The optical detection apparatus and the light detector elements included in the optical detection apparatus are described in more detail below with reference to FIGS. 3A and 3B. FIG. 3A depicts an example of a configuration of the light receiving face side of the light receiving face side of the optical detection apparatus together with arrow marks for use in description of dimensions and dots indicative of positions. FIG. 3B depicts the optical detection apparatus accommodated in a housing.

The optical detection apparatus 280 depicted in FIG. 3A includes multiple detector arrays 282-1 to 282-3 in each of which light detector units 281 are lined up in a row.

Although each detector array includes, in FIGS. 3A, 10 light detector units, the number of light detector units included in each detector array is not restricted to 10. Further, although the optical detection apparatus 280 includes, in FIG. 3A, three detector arrays, the number of detector arrays included in the optical detection apparatus is not restricted to three. A specific example of the number of light detector units included in each detector array and the number of detector arrays included in the optical detection apparatus is hereinafter described.

As depicted in FIG. 3B, the optical detection apparatus 280 may be configured as a module housed in a housing 285 having a window through which the light detector arrays 282 are exposed. The module may be connected, for example, to the information processing section through a cable 286.

The multiple detector arrays 282-1 to 282-3 are arranged in such a manner as to be lined up along a direction DB (referred to also as an “intersecting direction DB”) intersecting with the arraying direction DA of the light detector arrays. The arraying direction DA and the intersecting direction DB are described below.

The multiple detector arrays 282-1 to 282-3 are arranged such that the rows of the light detector elements thereof extend substantially in parallel to each other as depicted in FIG. 3A. In particular, the arraying direction DA signifies a direction that is substantially parallel to a row of the light detector elements configuring the detector array.

Further, in FIG. 3A, the three detector arrays 282 are arranged along the intersecting direction DB. In particular, the intersecting direction DB may signify a direction that is not parallel to the rows of the light detector elements. More specifically, the multiple detector arrays 282 may be arranged such that “a line interconnecting the center position (for example, C1) of one detector array and the center position (for example, C2) of another array that exists adjacent to the one detector array (is arranged closest)” intersects with the arraying direction DA.

In FIG. 3A, the detector array 282-1 and the detector array 282-2 are arranged such that a line interconnecting the center position C1 of the detector array 282-1 and the center position C2 of the detector array 282-2 intersects orthogonally with the arraying direction DA. Further, the detector array 282-2 and the detector array 282-3 are arranged such that a line interconnecting the center position C2 of the detector array 282-2 and the center position C3 of the detector array 282-3 intersects orthogonally with the arraying direction DA. In short, the three detector arrays are arranged such that the center positions of the three detector arrays define a straight line and the straight line intersects orthogonally with the arraying direction DA.

It is to be noted that, as hereinafter described, the positions of the detector arrays may be changed in the arraying direction, or in other words, the line interconnecting the center positions of them may not necessarily intersect orthogonally with the arraying direction and may intersect with the arraying direction such that an angle smaller than 90 degrees is formed between them insofar as this is permissible for optical detection.

One or more, two or more, or three or more of the light detector elements configuring each of the light detector arrays 282-1, 282-2, and 282-3 may be configured to detect light of a same wavelength and specifically may be used as the same fluorescence channel. For example, one or more, two or more, or three or more of the light detector elements configuring the light detector array 283-1 may be configured to detect light in a wavelength range same as that of one or more, two or more, or three or more of the light detector elements configuring the light detector array 283-2 or 283-3. For example, each light detector array may include one or more, two or more, or three or more light detector elements used as a same fluorescence channel.

In such a manner, one or more, two or more, or three or more of light detector elements configuring each of multiple light detector arrays included in the optical detection apparatus used in an embodiment of the present disclosure may be configured to detect light within the same wavelength range and particularly may be used as the same fluorescence channel. Further, five or more, 10 or more, or 15 or more of light detector elements configuring each of multiple light detector arrays may be configured to detect light in the same wavelength range.

Further, there is no necessity for all light detector arrays to include an equal number of light detector elements. For example, the light detector arrays may include light detector elements different from each other. For example, at least one of the multiple light detector arrays may include five or more, 10 or more, or 15 or more light detector elements.

For example, one half or more, two thirds or more, three fourths or more, or four fifths or more of the light detector elements configuring each of the multiple light detector arrays may be configured to detect light in the same wavelength range.

In several embodiments, all of the light detector elements configuring each of multiple light detector arrays included in the optical detection apparatus may be configured to detect light in the same wavelength range and particularly may be used as the same fluorescence channel.

It is to be noted that one or more light detector elements that do not detect light in the same wavelength range between the light detector arrays may exist.

Advantages produced by the flow cytometer including the optical detection apparatus configured in such a manner as described above and an example of a use method of the optical detection apparatus and the flow cytometer are described below.

In the flow cytometer depicted in FIG. 1, each of multiple optical detection apparatuses includes a light detector array (multiple light detector units lined up in a row). In this case, in order to introduce light to and spectrally disperse the light with each optical detection apparatus, it may be necessary to provide the number of light guide optical systems, spectral optical systems, and telecentric condensing lenses corresponding to the number of the optical detection apparatuses.

On the other hand, in the flow cytometer depicted in FIG. 2, multiple detector arrays are provided in one optical detection apparatus. Thus, the number of light guide optical systems, spectral optical systems and telecentric condensing lenses can be reduced. This makes it possible to downsize the flow cytometer and particularly downsize the detection section.

Further, for example, by each detector array, a spectrum of light generated from a bioparticle (for example, a fluorescence spectrum) can be acquired. Further, the spectrum of light generated by light application to a bioparticle from multiple excitation ray sources (specifically, multiple excitation light sources of wavelengths different from each other) can be acquired.

Further, with multiple detector arrays arranged along a direction intersecting with the arraying direction (specifically, along an orthogonal direction), an image of a bioparticle moving at high speed may be acquired.

For example, each of multiple light detector elements configuring one detector array can be configured to acquire a signal intensity of light generated by light application to a bioparticle at one light irradiation position (for example, a signal intensity of light at the same wavelength or in the same wavelength range, specifically, a signal intensity distribution in a direction transverse to the flow path). Further, by acquisition of the signal intensity being performed over a predetermined period of time, distribution state data of the signal intensity at individual points of time is obtained. By pieces of distribution state data being lined up along the time axis, two-dimensional image data of the bioparticle can be obtained. In other words, the light detector array is used to scan a flowing particle.

Since the optical detection apparatus includes multiple light detector arrays, the detector arrays may be configured such that they acquire light generated by light application to a bioparticle with rays of light (excitation light) of wavelengths different from each other at multiple light irradiation positions. This makes it possible to acquire multiple pieces of image data based on light generated by application of rays of light of individual wavelengths.

In such a manner, the flow cytometer (especially, the optical detection apparatus) according to an embodiment of the present disclosure may be configured to acquire an image of the bioparticle.

Further, while the optical detection apparatus includes multiple detector arrays, some of the multiple detector arrays may acquire a spectrum of light (especially, fluorescence) generated by light application to a bioparticle as described above while the remaining detector arrays may acquire image data of the bioparticle in such a manner as described hereinabove. Since the flow cytometer according to an embodiment of the present disclosure includes the optical detection apparatus described above, it may be configured to acquire both spectrum data and image data as described above.

Further, it is also possible to acquire position information when the bioparticle passes a light irradiation position, by using the optical detection apparatus. The position information can be acquired in reference to signals obtained from the detector arrays, for example, because the detector arrays are arranged in such a manner as to be orthogonal to the flow direction. In order to acquire the position information, for example, all of multiple light irradiation positions are irradiated with light of the same wavelength to acquire a spectrum of light in the flow direction.

### (2) Example of Configuration of Optical Detection Apparatus

An example of a configuration of the optical detection apparatus is described in more detail below.

As depicted in FIG. 3A, the optical detection apparatus according to an embodiment of the present disclosure includes multiple detector arrays in each of which light detector elements are lined up in a row. The light detector element may also be called a light detector unit. In other words, units having a function as a light detector may be lined up in a row.

The number of light detector elements included in each detector array is, for example, five or more in order to detect light spectrally dispersed for each desired wavelength, preferably 10 or more, and more preferably 15 or more.

The number of light detector elements included in each detector array is, from a point of view of easy manufacture of the optical detection apparatus, 100 or less, preferably 70 or less, and more preferably 50 or less. In several embodiments, the number may be, for example, 45 or less, 40 or less, or 35 or less. The number of light detector elements may be, for example, 64, 48, 32, 16, 8, or the like, and especially may be 32 or 16. The number of light detector units corresponds to the number of fluorescence channels of the flow cytometer. The number of light detector elements included in each detector array may be changed according to the number of channels.

Further, each detector array may be used as one that is equivalent to a detector array in which the number of light detector elements is smaller, by adding up and processing signals obtained from multiple consecutive light detector elements. By signals being added up and processed in such a manner, the detector array can be treated equivalently to a detector array including a smaller number of light detector elements. In other words, it is also possible to allow a detector array to correspond to a fluorescence channel number without changing the number of light detector elements.

Each light detector element may be a photomultiplier tube or may be an avalanche photodiode. In other words, all light detector elements configuring each detector array may be photomultiplier tubes or may be avalanche photodiodes. In several embodiments, each detector array may include a photomultiplier tube and an avalanche photodiode.

In a preferred embodiment, each light detector element may be a photomultiplier tube. In other words, each of the multiple light detector arrays may be a light detector array including photomultiplier tube elements lined up in a row.

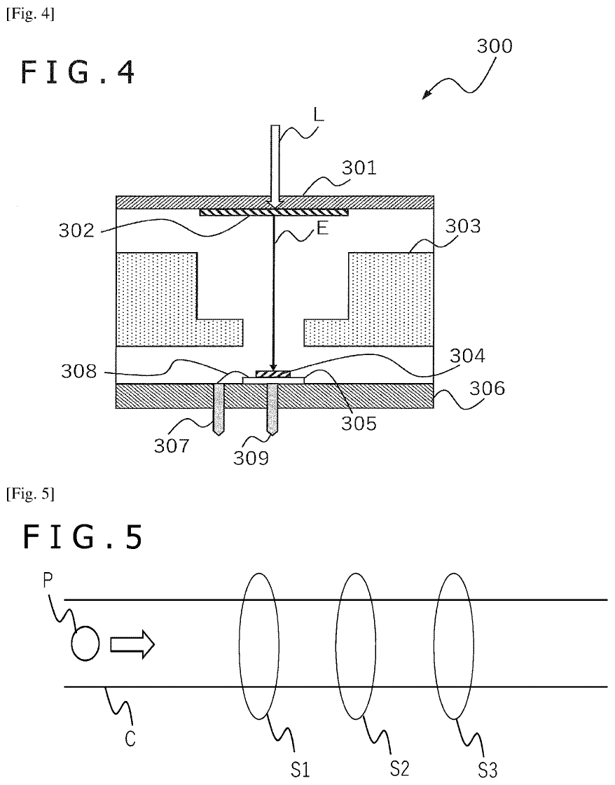

The photomultiplier tube element (hereinafter referred to also as a “photomultiplier tube”) may be of a type that includes a dynode including a semiconductor element. As a photomultiplier tube including a dynode including a semiconductor element, for example, an HPD (Hybrid Photo Detector) can be mentioned. An example of a configuration of the HPD is described with reference to FIG. 4. An HPD 300 depicted in FIG. 4 includes an entrance window 301 through which light generated from a bioparticle enters, a photoelectric surface 302 that emits electrons (photoelectrons) therefrom in response to arrival of the light, a focusing electrode section 303 that accelerates the photoelectrons, and a semiconductor element 304 (especially, an avalanche breakdown diode) that multiplies the electrons in response to entrance of the electrons and outputs an electric signal. The semiconductor element 304 may be kept fixed to a substrate 305. Further, the substrate 305 may be fixed to a base 306. The HPD 300 further includes a feeding section 307, a wire 308 that connects the feeding section 307 and the substrate 305 to each other, and a signal extraction section 309 that extracts a signal from the semiconductor element 304.

Light L incident through the entrance window 301 arrives at the photoelectric surface 302. When the light arrives at the photoelectric surface 302, a photoelectron E is emitted from the photoelectric surface. The photoelectron progresses toward the avalanche diode 304 while being accelerated by the focusing electrode section 303. The semiconductor element 304 is configured to function as a dynode (electron multi-plication section). The semiconductor element 304 generates an electron-hole pair according to incident energy of the photoelectron. If the photoelectron enters the photoelectron entrance surface of the semiconductor element, then the photoelectron is multiplied by the semiconductor element, and an electric signal is outputted.

The photoelectron multiplier tube unit that includes a dynode including the semiconductor element is superior in unit photoelectron dissolution and is superior especially in detection of weak light (especially, fluorescence or scattered light) generated from a bioparticle.

The photoelectron multiplier tube unit may be of a type that includes multiple stages of dynodes. As such a photoelectron multiplier tube as just described, for example, a photoelectron multiplier tube of the metal channel type or the micro channel plate type may be used. Such a photoelectron multiplier tube as just described is suitable specifically for detecting weak light generated from a bioparticle. Otherwise, a photoelectric multiplier tube of a circular cage type, a box type, a line focus type, a box line type, a circular line type, or a venetian blind type may be used as the photoelectron multiplier tube unit.

In another preferred embodiment, each light detector unit may be an avalanche photodiode. In other words, the multiple light detector arrays may include multiple light detector arrays in each of which avalanche photodiodes are lined up in a row. As an example of the optical detection apparatus in this embodiment, a multi-pixel photon counter (MPPC) can be mentioned. However, this is not restrictive.

In a further preferred embodiment, the multiple light detector arrays may include both a light detector array in which photoelectron multiplier tube units are lined up in a row and a light detector arrays in which avalanche photodiode units are lined up in a row.

For example, from the MPPC, signals outputted from the multiple avalanche photodiodes are outputted as an added up signal. Meanwhile, the arrays of photomultiplier tube elements can output a signal from each photoelectron multiplier tube element. Thus, preferably, the multiple light detector arrays may be arrays of the photoelectron multiplier tube elements. Alternatively, each element of the arrays may include an MPPC.

The multiple light detector arrays may be configured such that gains thereof can be adjusted independently of each other. In particular, the optical detection apparatus may be configured such that gain adjustment in a unit of an array can be performed. The gain adjustment can be performed easily especially in a case where the light detector element is a photoelectron multiplier tube or an avalanche photodiode.

In a case where multiple rays of laser light of wavelengths different from each other are used to irradiate a bioparticle, signal strengths of fluorescence light generated by light application of laser light are often different. In a case where one laser light and one array are associated with each other, signal output adjustment according to the strength of the laser light (or signal strength of light generated by application of the laser light) can be performed by gain adjustment for each array, and this contributes to easy performance of analysis of optical data.

In particular, the flow cytometer according to an embodiment of the present disclosure may be configured such that the gain of each light detector array can be adjusted. For example, the flow cytometer may be configured such that the gain of each light detector array can be adjusted, for example, according to the signal intensity of each light (especially, each laser light) emitted from the light irradiation section or according to the signal strength of light generated by light application. For example, the information processing section hereinafter described may acquire data relating to the intensity of each light or the signal intensity of light generated by the light irradiation and then adjust the gain of each light detector array in reference to the data.

The multiple light detector elements included in the light detector array may be configured such that the gains thereof can be adjusted independently of each other. In particular, the optical detection apparatus may be configured such that the gain adjustment can be performed for each light detector element. The gain adjustment can be executed easily especially in a case where the light detector element is a photoelectron multiplier tube or an avalanche photodiode.

The signal intensity of detected light sometimes differs depending upon the position of one light detector array in the arraying direction. Hence, adjusting the gain of each light detector element in the detector array makes it possible to obtain a more appropriate analysis result.

In particular, the flow cytometer according to an embodiment of the present disclosure may be configured such that the gain of each light detector element in the detector arrays can be adjusted. For example, in the flow cytometer, the gain can be adjusted for each light detector element in the detector arrays according to the signal intensity of light detected by each light detector element. For example, the information processing section hereinafter described may acquire data relating to the signal intensity of light detected by each detector element and adjust the gain of each light detector element in reference to the data.

Further, as depicted in FIGS. 2 and 3, the optical detection apparatus 280 includes multiple detector arrays 282 in each of which light detector units 281 are lined up in a row. The number of detector arrays included in the optical detection apparatus 280 is not restricted to three or 10 in FIGS. 2 and 3. The number of detector arrays may be, for example, equal to the number of light irradiation positions or may be equal to the number of types of laser sources included in the light irradiation section.

The number of detector arrays included in the optical detection apparatus may be, for example, two or more, preferably three or more, more preferably four or more.

Although the upper limit of the number of detector arrays included in the optical detection apparatus may not be restricted specifically, it may be, for example, 20 or less, particularly 15 or less, more particularly ten or less, nine or less, or eight or less.

The optical detection apparatus may include a housing or a passage window configured to allow light generated by light application to a bioparticle to pass therethrough. The shape of the housing or the passage window may be a rectangular shape as depicted in FIGS. 2 and 3 or may be a circular shape. The size L1 of the housing or the passage window may be, for example, 100 mm or less, preferably 80 mm or less, and more preferably 60 mm or less. Although the lower limit of the size L1 may not be restricted specifically and may be changed suitably, for example, according to the size and the number of light detector arrays, it may be, for example, 5 mm or more, 10 mm or more, 20 mm or more, or 30 mm or more.

In a case where the shape of the housing or the passage window is a rectangular shape, the size L1 is a length of one side or a long side, and in a case where the shape of the housing or the passage window is a circular shape, the size L1 signifies a diameter of the circular shape. It is to be noted that the circular shape includes a true circle and an ellipse. In a case where the circular shape is an ellipse, the size signifies a size of the long diameter of the ellipse.

The multiple light detector arrays may be arranged at pitch intervals LP of, for example, 5 mm or less in the intersecting direction, and particularly may be 4 mm or less, preferably 3 mm or less, more preferably 2 mm or less, and in several embodiments, may be equal to or smaller than 1 mm or less.

The lower limit of the pitch interval may be determined according to the size of each light detector unit in the intersecting direction (especially, in an orthogonal direction), and, for example, in a case where adjacent light detector arrays are in contact with each other, the size of the light detector arrays corresponds to the lower limit of the pitch interval. Thus, although the lower limit of the pitch interval need not be restricted specifically, it may be, for example, 0.3 mm or more, preferably 0.4 mm or more, more preferably 0.5 mm or more, most preferably 0.6 mm or more.

The pitch interval is an interval between two light detector arrays adjacent to each other and is, for example, an interval between central positions in dimensions of two adjacent detector arrays in their intersecting direction (flow direction).

The overall length LA of each of the multiple light detector arrays in the arraying direction in which the light detector units are lined up may be, for example, 50 mm or less, preferably 40 mm or less, more preferably 30 mm or less, especially may be equal 20 mm or less, or otherwise may be 15 mm or less.

The overall length described above may be, for example, 3 mm or more, preferably 5 mm or more, more preferably 7 mm or more.

The pitch interval of the light detector units in each light detector array may be, for example, 0.05 mm or more, preferably 0.1 mm or more, more preferably 0.2 mm or more.

The pitch interval described above may be, for example, 5 mm or less, preferably 3 mm or less, more preferably 1 mm or less.

Although there may be a dead zone between adjacent light detector units in each light detector array, the width of the dead zone is preferably 100 μm or less, more preferably 80 μm or less, most preferably 70 μm or less. Preferably, the width of the dead zone is 30% or less of the size of each light detector unit in the arraying direction, preferably 25% or less, more preferably 20% or less.

The size Ldb of each light detector unit in a direction perpendicular to the arraying direction may be, in order to detect light with higher certainty, 0.3 mm or more, preferably 0.4 mm or more, more preferably 0.5 mm or more, and most preferably 0.6 mm or more.

The size Ldb described above may be, from a point of view of downsizing the optical detection apparatus, for example, 3 mm or less, preferably 2 mm or less, more preferably 1.5 mm or less.

Further, the size Lda of each light detector unit in a direction parallel to the arraying direction may be, in order to detect light with higher certainty, 0.3 mm or more, preferably 0.4 mm or more, more preferably 0.5 mm or less, and may further be 0.6 mm or more.

The size Lda described hereinabove may be, from a point of view of downsizing the optical detection apparatus, 3 mm or less, preferably 2 mm or less, more preferably 1.5 mm or less.

The optical detection apparatus may be of a type that has a photoelectric surface. In other words, each light detector unit may have a photoelectric surface.

The highest quantum efficiency of photoelectric conversion by the photoelectric surface may be, for example, 5% or more, preferably 10% or more, more preferably 15% or more.

Further, although the upper limit of the highest quantum efficiency may not be set specifically, it may be, for example, 60% or less, 50% or less, or 40% or less.

The cathode lumen sensitivity of the photoelectric surface is, for example, 100 μA/lm or more, preferably 200 μA/lm or more, more preferably 300 μA/lm or more, most preferably 400 μA/lm or more.

Although the upper limit of the cathode lumen sensitivity of the photoelectric surface may not be restricted specifically, it may be, for example, 1000 μA/lm or less.

In a case where the optical detection apparatus includes a light detector array in which photoelectron multiplier tube units are lined up in a row, the current amplification factor of the dynode of each photoelectron multiplier tube unit may be, for example, 10⁴ or more, preferably 10⁵ or more, more preferably 0.5×10⁶ or more, most preferably 10⁶ or more.

Although the upper limit of the current amplification factor may not be restricted specifically, it may be, for example, 10¹² or less, 10¹⁰ or less, or 10⁸ or less.

In a case where the optical detection apparatus includes a light detector array in which photoelectron multiplier tube units are lined up in a row, the dark current of the dynode of each photoelectron multiplier tube unit is, per photoelectron multiplier tube unit, for example, 5 nA or less, preferably 4 nA or less, more preferably 3 nA or less. The dark current preferably is made as small as possible, and although the lower limit of the dark current need not be restricted specifically, it may be, for example, 0 nA or more per photoelectron multiplier tube unit.

Further, the dynodes of the light detector units may be configured such that the gains thereof can be corrected independently of each other.

The lower limit of the ratio between the gains that can be adjusted in the elements in the array may be, for example, 1:1, 10:1 or 100:1 or more. The upper limit of the ratio may be at least 100:1, preferably 1000:1, more preferably 10000:1.

The ratio is used in order to correct the dispersion in gain or sensitivity of the element itself and correct the dispersion such that, when an equal amount of light is inputted, an equal output is outputted. Further, if there is a wavelength region in which spectrum light obtained from a sample is typically dark, then correction for raising the gain of an element corresponding to the wavelength region may be performed.

Each optical detection apparatus may include an outputting circuit that outputs an electric signal. The outputting circuit may be configured such that, for example, the maximum output signal voltage of each of the light detector units is, in time average, 0.01 V or more, preferably 0.03 or more, more preferably 0.05 or more.

Further, the outputting circuit may be configured such that the highest output signal voltage of each light detector unit is, for example, in time average, 10 V or less, preferably 1 V or less.

The frequency band of the outputting circuit may be, for example, DC-5 MHZ, preferably DC-4 MHz, more preferably DC-3.5 MHz, and in several embodiments, may be DC-3 MHz, DC-2.5 MHz, or DC-2 MHZ.

The current-voltage conversion characteristic of the outputting circuit may be, for example, 0.001 V/μA or more, preferably 0.005 V/μA or more.

The current-voltage conversion characteristic of the outputting circuit may be, for example, 10 V/μA or less, preferably 1 V/μA or less.

The outputting circuit may include, for example, a low pass filter in order to reduce ripple noise, or may include another circuit known in the relevant technical field for reducing such ripple noise or may be subjected to a known process for such ripple noise reduction.

In regard to the outputting circuit, the crosstalk between the light detector units may be, for example, 3% or less, preferably 2% or less, more preferably 1.5% or less. The value of the crosstalk is a ratio where the signal output of a light incident element when light enters only a specific element is the denominator and the signal output of an adjacent element is the numerator.

### (3) Relation with Light Irradiation Section

In a preferred embodiment of the present disclosure, the flow cytometer may include a light irradiation section that irradiates a bioparticle flowing in the flow path with light at multiple light irradiation positions along the flow direction of the flow path. Since the optical detection apparatus described above includes multiple light detector arrays, using them in combination with the light irradiation section that irradiates the bioparticle with light at multiple positions in the flow path makes it possible to perform, while downsizing of the flow cytometer is achieved, detailed bioparticle analysis based on light generated by light application at the positions. In particular, the flow cytometer according to an embodiment of the present disclosure may include a light irradiation section that includes two or more laser sources that perform off-axis irradiation.

The light irradiation section that irradiates multiple light irradiation positions with light may be configured to emit rays of light having wavelengths different from each other to the multiple light irradiation positions. The wavelengths of the rays of light for the application may be wavelengths, for example, of 200 to 1000 nm, and particularly of 300 to 900 nm. The light irradiation section may include multiple laser sources each of which emits laser light having a central wavelength of one of values within the wavelength range. Rays of laser light emitted from the multiple laser sources are individually used for application at the multiple light irradiation positions.

In several embodiments of the present disclosure, the flow cytometer may include a light irradiation section that irradiates a bioparticle flowing in the flow path with light at one light irradiation position in the flow path. The optical detection apparatus described hereinabove may be incorporated, in combination with the light irradiation section, in the flow cytometer. In other words, the flow cytometer according to an embodiment of the present disclosure may include two or more laser sources by which coaxial irradiation is performed. To the wavelength of light to be used for irradiation, the description of the case of off-axis irradiation applies.

In this embodiment, the two or more laser sources are combined, for example, by a predetermined optical system and used for irradiation at the one light irradiation position described above. The predetermined optical system may include, for example, one or more half mirrors and/or one or more dichroic mirrors and so forth, and can be designed suitably by a person skilled in the art.

In a particularly preferred embodiment of the present disclosure, the flow cytometer may include a light irradiation section that irradiates a bioparticle flowing in the flow path with light at multiple light irradiation positions along the flow direction of the flow path and may configured such that light originating from light application at two or more positions among the multiple light irradiation positions is detected by one optical detection apparatus, and specifically may be configured such that light originating from light irradiation at all of the multiple light irradiation positions is detected by the single optical detection apparatus.

This makes it possible to reduce the number of optical elements such as light detector side light guide optical systems, diffraction gratings, and telecentric condensing lenses as described hereinabove and downsize the flow cytometer.

The multiple light detector arrays included in the optical detection apparatus may be associated with light sources (specifically with laser light sources) included in the light irradiation section. The association relation is described below with reference to FIG. 5.

FIG. 5 depicts three light irradiation positions S1, S2, and S3. The light irradiation positions are irradiated with rays of laser light L1, L2, and L3, respectively. In particular, the light irradiation section is configured to emit the rays of laser light L1, L2, and L3 for the irradiation at the light irradiation positions P1, P2, and P3, respectively. The rays of laser light L1, L2, and L3 may be rays of light having wavelengths different from one another. The three light irradiation positions may be observed through one objective lens. Further, each ray of light generated by light application at the three light irradiation positions may be detected by one optical detection apparatus.

In such a manner, the flow cytometer according to an embodiment of the present disclosure may be configured such that light generated by light application at multiple light irradiation positions is detected by a single optical detection apparatus.

A bioparticle P flows in a flow path C and is irradiated with the laser light L1 first, and then is irradiated with the laser light L2, and finally is irradiated with the laser light L3. By each light application, light (for example, fluorescence and/or scattered light or the like) is generated from the bioparticle.

Further, the optical detection apparatus that detects the light generated by the light application at the positions may include three detector arrays, for example, as depicted in FIG. 2 or 3. The optical detection apparatus includes detector arrays 282-1, 282-2, and 282-3. The detector array 282-1 may be associated with the laser light L1, and similarly, the detector array 282-2 may be associated with the laser light L2, and the detector array 282-3 may be associated with the laser light L3. More specifically, the detector array 282-1 detects light generated by light application with the laser light L1 to the particle; the detector array 282-2 detects light generated by light application with the laser light L2 to the particle; and the detector array 282-3 detects light generated by light application with the laser light L3 to the particle. In such a manner, the light irradiation positions and the detector arrays may be associated with each other in advance.

In particular, the multiple light irradiation positions are lined up along the flow direction of a particle, and besides the multiple detector arrays in the optical detection apparatus may be lined up to be associated with the multiple light irradiation positions. The lineup order of the multiple detector arrays may be the same as the lineup order of the light irradiation positions at which light application with which rays of light to be detected individually by the multiple detector arrays are generated is performed. In other words, the multiple detector arrays may be lined up in such a manner as to correspond to the flow direction of the particle.

### (4) Modifications of Optical Detection Apparatus

### (4-1) Change of Position

The optical detection apparatus described in (2) above includes multiple light detector arrays. Each of the light detector arrays may be configured such that the position thereof can be changed. Such a position change of the light detector arrays is described in connection with examples thereof.

(4-1-1) Position change of light detector array in flow direction

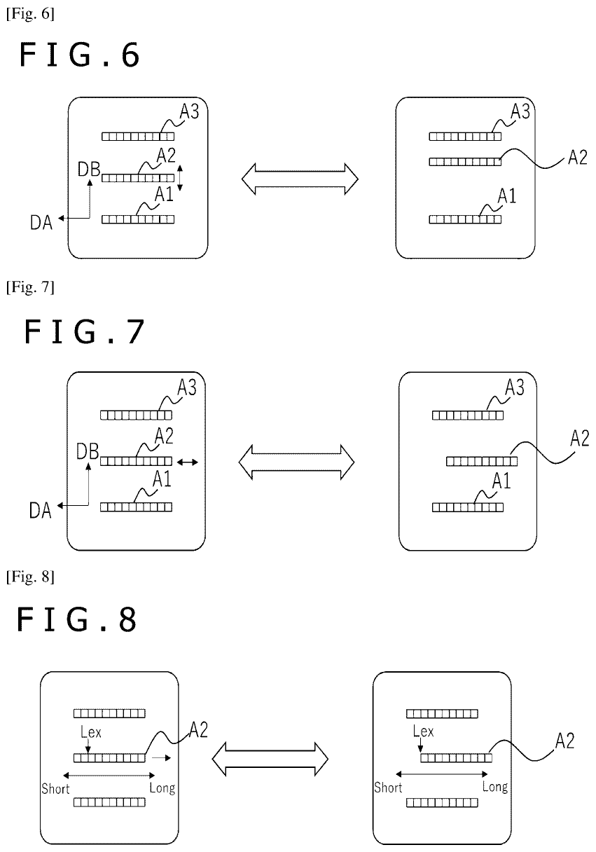

In one embodiment, the multiple light detector arrays may be configured such that the position of one or more of them in the arraying direction of the arrays can be changed independently of each other. In other words, they may be configured such that the interval between the arrays can be adjusted. This is described with reference to FIG. 6.

FIG. 6 depicts three detector arrays A1 to A3. They may be configured such that one or more of them are movable along the array arraying direction DB.

For example, as depicted in FIG. 6, among the three arrays, only the array A2 may be configured such that the position thereof can be changed and the arrays A1 and A3 may be configured such that the positions thereof are not allowed to be changed. In particular, the array A2 can move toward the array A3 or can move toward the array A1.

Two of the three arrays may be configured such that the positions thereof can be changed. For example, the position of the array A2 may be fixed while the positions of the arrays A1 to A3 may be changeable. The arrays A1 and A3 may be configured to be movable along the array arraying direction DB. Alternatively, while the array A1 is fixed, the arrays A2 and A3 may be configured to be movable along the array arraying direction DB or while the array A3 is fixed, the arrays A1 and A2 may be configured such that the positions thereof can move along the arraying direction DB.

All of the three arrays may be configured such that the positions thereof can be changed. In other words, all of the arrays A1 to A3 may be configured to be movable along the arraying direction DB.

Although the foregoing description is given in regard to the optical detection apparatus that includes three detector arrays for simplified description, also in a case where the optical detection apparatus includes four or more detector arrays, they may similarly be configured such that the position of one or more of them can be changed.

Adjusting the interval between the arrays in such a manner makes it possible to implement an appropriate array interval according to a magnification of the flow path side optical system or the detector side optical system or to a configuration or a state of the flow path side optical system or the detector side optical system. For example, depending upon an optical part of the flow path side optical system or the detector side optical system, there may possibly be a case in which it is difficult to allow light generated by light application to arrive at the optical detection apparatus while the interval between the light irradiation positions is kept reflected. Also there is a case in which the position of the light irradiation position in the flow direction is displaced. In those cases, more appropriate optical detection becomes possible by adjustment of the array interval as described above.

### (4-1-2) Position Change of Light Detector Array in Arraying Direction

In another embodiment, the multiple light detector arrays may be configured such that the position of one or more of them in the direction in which the light detector units are lined up can be changed independently of each other. This is described with reference to FIG. 7.

FIG. 7 depicts three detector arrays A1 to A3. The detector arrays A1 to A3 may be configured such that one or more of them can be moved in a direction (detector unit arraying direction) DA in which the light detector units are lined up.

For example, the three arrays may be configured such that the position of only the array A2 can be changed and the positions of the arrays A1 to A3 are not allowed to be changed. In particular, the array A2 can move along the detector unit arraying direction and can move, for example, leftwardly or rightwardly in FIG. 7.

The three arrays may be configured such that the positions of two of them can be changed or the positions of all three of them can be changed.

Although the foregoing description is given of the optical detection apparatus that includes three detector arrays for simplified description, also in a case where the optical detection apparatus includes four or more detector arrays, they may similarly be configured such that the position of one or more of them can be changed.

Adjusting the positions of the arrays in the detector unit arraying direction in such a manner as described above makes it possible to efficiently detect light generated by light application. For example, adjusting the positions according to the position of a particle in a flow path in which the particle flows enables more appropriate optical detection. Further, in a case where a wavelength of light to be detected by each detector unit is set in advance, it is also possible to more efficiently detect desired light by changing the positions described above.

For example, in a case where fluorescence light is spectrally dispersed for each wavelength by a spectral optical system, rays of light of wavelengths after the spectral dispersion are consecutively lined up from short wavelength light to long wavelength light along the arraying direction of the detector arrays. Here, fluorescence light usually has a wavelength of excitation light or a wavelength longer than that of excitation light. Hence, in a case where the position in the arraying direction is kept fixed, despite that fluorescence light of a wavelength shorter than that of the excitation light does not exist, at a position in one detector array at which fluorescence light of the wavelength that does not exist is to arrive, some light detector elements in the light detector array exist. These light detector elements can be regarded as not being effectively used in optical detection. Hence, moving the position of the light detector array in the arraying direction makes it possible to reduce such light detector elements that are unable to be used effectively in optical detection.

For example, as depicted on the left side in FIG. 8, in the light detector array A2, the light detector elements are arranged in a lined up relation from a position (Short) at which light of a short wavelength side arrives to a position (Long) at which light of a long wavelength side arrives. Here, in a case where the wavelength of the excitation light with which fluorescence light to be detected by the light detector array A2 is generated is that of light having a wavelength at a position denoted by Lex, fluorescence light on the shorter wavelength side than Lex does not exist. Hence, the position of the light detector array A2 is moved to the long wavelength side as depicted on the right side in FIG. 8. This can reduce light detector elements that are not effectively used in the detection of fluorescence light.

### (4-1-3) Position Change of Light Detector Array in Both Directions

In a further embodiment, the multiple light detector arrays may be configured such that the position of one or more of them in the array arraying direction can be changed independently of each other and the positions in the direction in which the light detector units are lined up can be changed independently of each other. Such position changes as just described are as such described hereinabove with reference to FIGS. 6 and 7.

In order to perform such a position change of the light detector arrays as described above, the optical detection apparatus may include an array position adjustment section. The array position adjustment section may be configured to perform array position adjustment using an electric power source such as a piezo actuator or a motor-and-screw feed mechanism, for example, or may be configured such that the array position is moved with use of a tool such as a driver and, after the adjustment, the position is fixed by a screw. The position of the light detector array can be controlled by the array position adjustment section. The array position adjustment section may be controlled in driving by the information processing section hereinafter described.

### (4-2) Modification of Light Detector Array

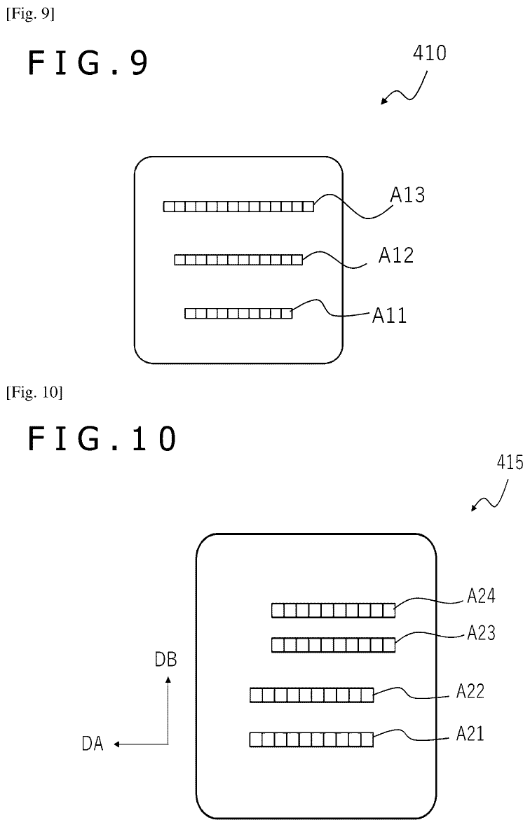

In FIG. 3 described in (2) above, all of the three light detector arrays include 10 light detector elements. Although the numbers of the light detector elements included in the light detector arrays may be equal to as depicted in FIG. 3, they may otherwise be different between two or more of the light detector arrays. For example, an optical detection apparatus 410 depicted in FIG. 9 includes three light detector arrays A11, A12, and A13. The number of light detector elements included in the light detector array A11 is 10, and the numbers of light detector elements included in the light detector array A12 and the light detector array A13 are 12 and 14, respectively. As described above, multiple light detector arrays included in the optical detection apparatus according to an embodiment of the present disclosure may have numbers of light detector elements different from each other. For example, the number of light detector elements of one or two or more light detector arrays among the multiple light detector arrays included in the optical detection apparatus may be different from the number of the multiple light detector arrays included in the optical detection apparatus of the other light detector arrays.

In FIG. 3 described in (2) above, the positions of the three light detector arrays in the arraying direction DA are the same as each other. Further, as described in (4-1) above, the light detector arrays may be configured such that the positions thereof can be changed in the arraying direction. In an embodiment of the present disclosure, the positions of the multiple light detector arrays in the arraying direction DA may be different from each other in advance. For example, an optical detection apparatus 415 depicted in FIG. 10 includes four light detector arrays A21, A22, A23, and A24. The positions of the light detector arrays A21 and A22 in the arraying direction DA are the same as each other. Also the positions of the light detector arrays A23 and A24 in the arraying direction DA are the same as each other. Meanwhile, the positions of the light detector arrays A21 and A22 in the arraying direction DA are different from the positions of the light detector arrays A23 and A24 in the arraying direction DA. In such a manner, the positions of the multiple light detector arrays included in the optical detection apparatus according to an embodiment of the present disclosure may be different from each other in the arraying direction. For example, the position of one or two or more light detector arrays among the multiple light detector arrays included in the optical detection apparatus in the arraying direction may be different from the position of any other light detector array in the arraying direction.

It is to be noted that the position of a light detector array in the arraying direction may signify a position of one of the opposite ends of the array in the arraying direction or may signify a center position of each array in the arraying direction.

### (4-3) Microlens Array

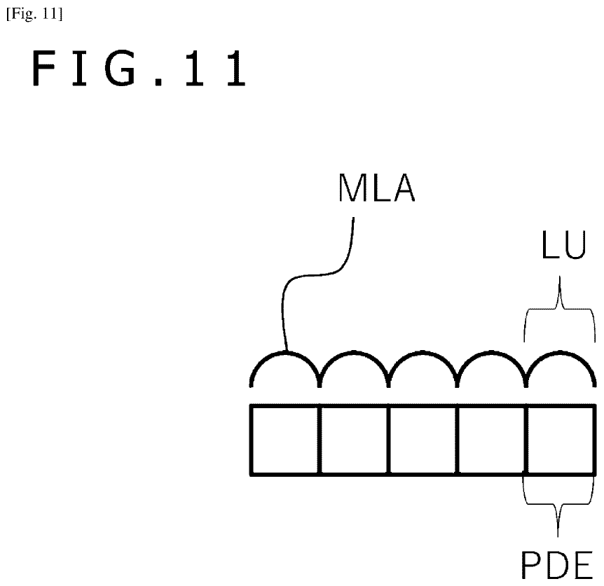

The optical detection apparatus may further include a microlens array. The microlens array may be configured such that light to be detected is condensed at each light detector unit. This configuration makes it possible to introduce light more efficiently into the light detector. The microlens array is described with reference to FIG. 11.

As depicted in FIG. 11, the microlens array MLA may be provided such that light is condensed at each of light detector elements PDE. In particular, the microlens array may be configured such that there is one microlens unit LU on one light detector element PDE.

The lens units of the microlens arrays may individually have a curvature in the arraying direction DB, may have a curvature in the array arraying direction DA (direction from this side of the figure toward the rear), or may have a curvature in both of the directions.

### (5) Use of Optical Fiber

The flow cytometer may have a propagation optical path that propagates light generated by the light application, to the optical detection apparatus, and the propagation optical path may include one or more optical fibers. The number of optical fibers may be changed suitably, for example, in accordance with a configuration of the optical fibers (specifically the number of cores) and/or the light irradiation positions.

For example, in a case where one optical fiber includes one core (for example, in a case where an optical fiber including one core, one clad surrounding the core, and a covering layer that surrounds the clad is used), for example, the number of optical fibers equal to the number of light irradiation positions may be used as the propagation optical path.

In a case where one optical fiber includes multiple cores (for example, in a case where an optical fiber including a clad including multiple cores and a covering layer surrounding the clad is used), the number of optical fibers smaller than the number of the light irradiation positions may be used as the propagation optical path.

In one embodiment, the propagation optical path includes multiple optical fibers. The multiple optical fibers may preferably be bundled. In other words, the propagation optical path may include an optical fiber bundle. Although each optical fiber may be of a type that includes one core, it may otherwise include multiple cores.

For example, the multiple optical fibers may be bundled such that the arrangement of the cores of the optical fibers is fixed at the light entrance side terminal end (end to which light generated by light application to a bioparticle enters).

Alternatively, the multiple optical fibers may be bundled such that the arrangement of the cores of the optical fibers is fixed at the light outgoing side terminal end (end from which light entering from the entrance side terminal end goes out).

Since the multiple optical fibers are bundled in such a manner, the multiple optical fibers can be disposed such that the cores thereof linearly form one row at the entrance side terminal end and/or the outgoing side terminal end.

In another embodiment, the propagation optical path may include one optical fiber, and multiple core-clad sets may be provided in the one optical fiber.

For example, the multiple core-clad sets may be fixed such that the arrangement of the multiple cores is fixed at the light entrance side terminal end.

Further, the multiple core-clad sets may be fixed such that the arrangement of the multiple cores is fixed at the light outgoing side terminal end.

The multiple optical fibers may be bundled.

With the arrangement of the cores being fixed in such a manner, the multiple cores of the optical fiber can be arranged to linearly form one row at the entrance side terminal end and/or the outgoing side terminal end.

In a further embodiment, the propagation optical path may include one optical fiber, multiple cores may be provided in the one optical fiber, and particularly, the multiple cores may be provided in one clad. This allows the arrangement of the multiple cores to be fixed at the light entrance side terminal end. Also at the light outgoing side terminal end, the arrangement of the multiple cores is fixed.

Since the arrangement of the cores is fixed in such a manner, the multiple cores of the optical fiber can be arranged to linearly form one row at the entrance side terminal end and/or the outgoing side terminal end.

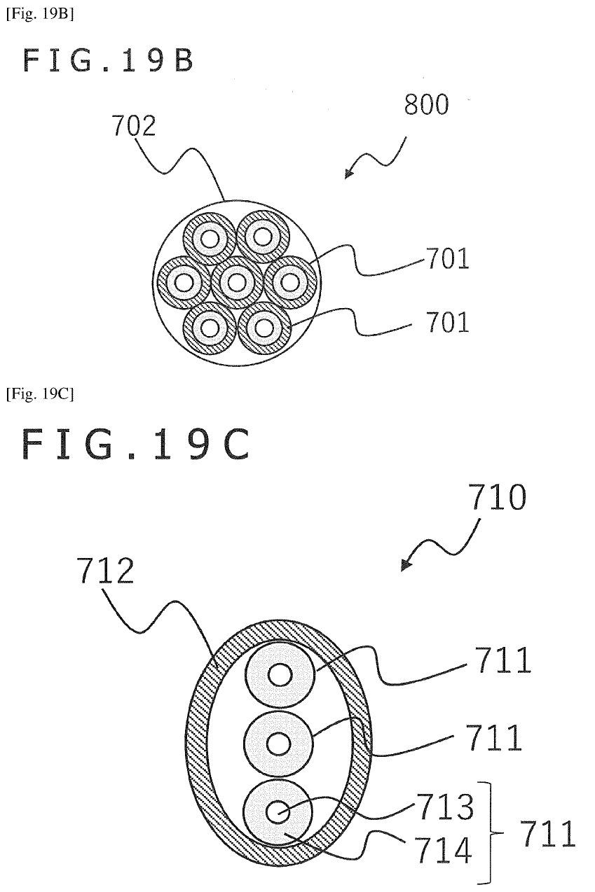

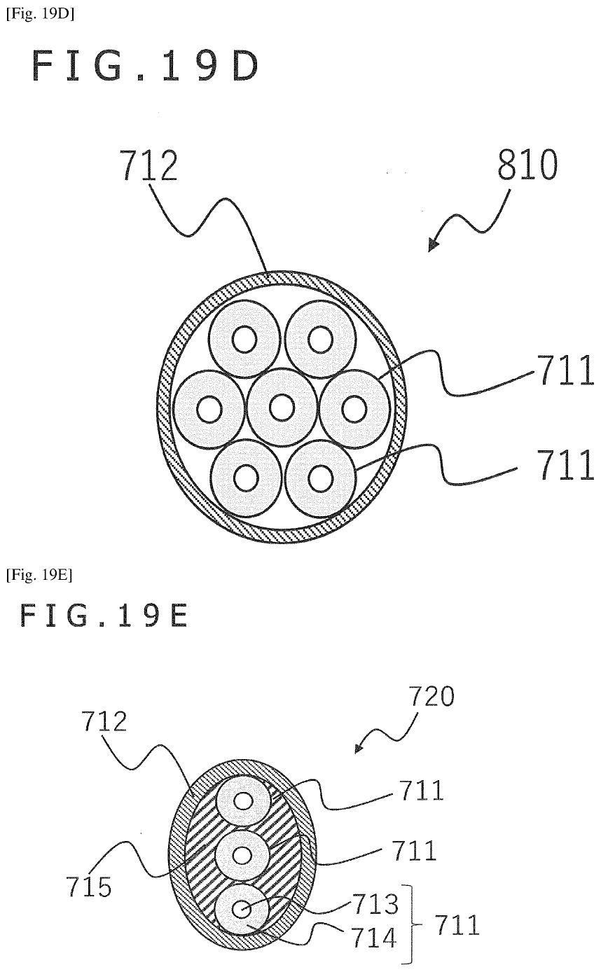

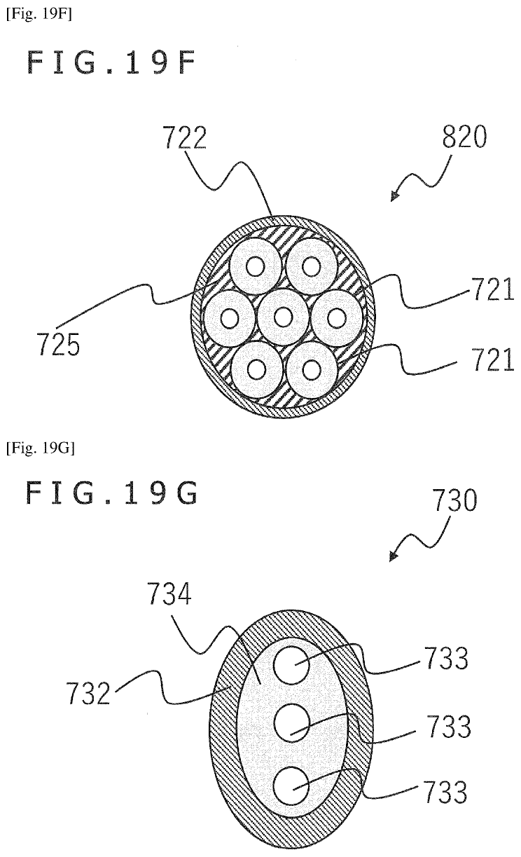

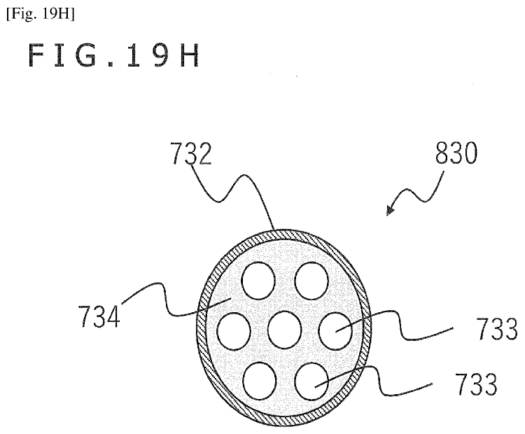

It is to be noted that examples of a configuration of the optical fiber are hereinafter separately described with reference to FIGS. 19A to 19H. Further, although an example in which an optical fiber is used as an example of a propagation optical path along which light generated by light irradiation is propagated to the optical detection apparatus in the flow cytometer described hereinabove is indicated, as the propagation optical path, desired means that can be used as a propagation optical path for light such as a rod integrator that fully reflects entering light in the inside thereof such that the entering light is propagated or the like may be used. In this case, the configuration described in the present specification can be used suitably except that desired propagation means of light is used in place of the optical fiber.

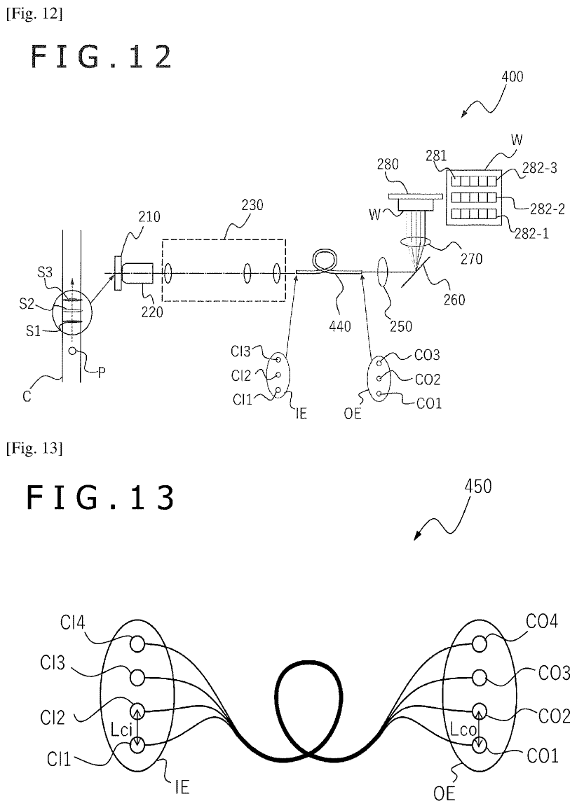

An example of a configuration of the flow cytometer according to an embodiment of the present disclosure having a propagation optical path including an optical fiber is described with reference to FIG. 12. A flow cytometer 400 depicted in FIG. 12 is the same as the flow cytometer 200 depicted in FIG. 2 except that an optical fiber bundle 440 is provided in place of the field diaphragm 240.

The optical fiber bundle 440 may be provided on an optical path between the flow cell 210 and the spectral optical system 260 as depicted in FIG. 12 and, for example, may be provided on an optical path between the flow path side light guide optical system 230 and the detector side light guide optical system 250.

The optical fiber bundle 440 may be a bundle of the number of optical fibers corresponding to the number of light irradiation positions, and in FIG. 12, three optical fibers are bundled. The optical fiber bundle 440 may be of a type having, for example, such a structure as depicted in FIG. 19A hereinafter described.

At the light entrance side terminal end IE of the optical fiber bundle 440, three optical fiber cores CI1, CI2, and CI3 exist as depicted in FIG. 12 (it is to be noted that, in FIG. 12, clads and covering layers are omitted). The optical fiber core CI1 is a core which light generated by light application to a bioparticle at the light irradiation position S1 enters. Similarly, the optical fiber cores CI2 and CI3 are a core which light generated by light application to a bioparticle at the light irradiation position S2 enters and a core which light generated by light application to a bioparticle at the light irradiation position S3 enters, respectively.

At the terminal end, the arrangement interval between the three optical fiber cores CI1, CI2, and CI3 is fixed. The arrangement interval may correspond to the interval between the light irradiation positions S1, S2, and S3. For example, the arrangement interval between certain two optical fiber cores present at the light entrance side terminal end may be set according to the “interval between two light irradiation positions at which light that enters the two optical fiber cores is generated” and the “magnification of the flow path side light guide optical system.” The magnification of the flow path side light guide optical system may be an optical magnification that depends upon, for example, one or more optical elements (for example, a lens or the like) present between the flow path to be irradiated with light and the light entrance side terminal end of the optical fiber bundle.

In such a manner, at the light entrance side terminal end, the arrangement of the multiple optical fiber cores may be fixed, and particularly, the multiple optical fiber cores may be arranged in such a manner as to correspond, at the light entrance side terminal end, to the intervals between the multiple light irradiation positions on the flow path. In this case, the interval between the optical fiber cores at the light entrance side terminal end may be the interval set, for example, according to (the interval between the light irradiation positions on the flow path) and (the magnification of the flow path side light guide optical system), and may be, for example, an interval equivalent to “(the interval between the light irradiation positions on the flow path) x (the magnification of the flow path side light guide optical system).”

At the light outgoing side terminal end OE of the optical fiber bundle 440, three optical fiber cores CO1, CO2, and CO3 are present as depicted in FIG. 12. The optical fiber core CO1 is a core from which light generated by light application to a bioparticle at the light irradiation position S1 is to be emitted. Similarly, the optical fiber cores CO2 and CO3 are a core from which light generated by light application to a bioparticle at the light irradiation position S2 is to be emitted and a core from which light generated by light application to a bioparticle at the light irradiation position S3 is to be emitted, respectively.

At the terminal end, the arrangement interval between the three optical fiber cores CO1, CO2, and CO3 is fixed. The arrangement interval may correspond to the interval between the light detector arrays 282-1 to 282-3 of the optical detection apparatus 280. For example, the arrangement interval between two certain optical fiber cores present at the light outgoing side terminal end may be set according to “the interval between two light detector arrays allocated to detect light emitted from the two optical fiber cores” and “the magnification of the detector side light guide optical system.” The interval between the light detector arrays may signify the interval in the intersecting direction DB. Further, the magnification of the detector side light guide optical system may be an optical magnification that depends upon, for example, one or more optical elements (for example, a lens or the like) present between the optical detection apparatus and the light outgoing side terminal end of the optical fiber bundle.

In such a manner, at the light outgoing side terminal end, the arrangement of the multiple optical fiber cores may be fixed, and particularly, the multiple optical fiber cores may be arranged in such a manner as to correspond, at the light outgoing side terminal end, to the intervals between the light detector arrays. In this case, the interval between the optical fiber cores at the outgoing side terminal end may be the interval set, for example, according to (the interval between the light detector arrays) and (the magnification of the detector side light guide optical system), and may be, for example, an interval equivalent to “(the interval between the light detector arrays) × (magnification of the detector side light guide optical system).”

It is to be noted that the arrangement of the light detector array corresponding to the light outgoing side terminal end of the multiple optical fiber cores described hereinabove may be suitably adjusted in line with the optical paths for light from the light outgoing side terminal end of the optical fiber bundle 440 to the optical detection apparatus 280 in such a manner as to match with the optical paths for light.

Conversely, it is also possible to adjust the arrangement of the light outgoing side terminal end of the optical fiber cores in line with the arrangement of the light detector array.

Here, the optical paths for light from the light outgoing side terminal end of the optical fiber bundle 440 to the optical detection apparatus 280 depend upon the detector side light guide optical system 250, the spectral optical system 260, and the telecentric condensing lens 270 to be used, upon a combination of them, or upon arrangement of the components.

A schematic example of an optical fiber bundle included in the flow cytometer according to an embodiment of the preset disclosure is depicted in FIG. 13. An optical fiber bundle 450 depicted in FIG. 13 is a bundle of four optical fibers. It is to be noted that, although FIG. 13 depicts the optical fiber bundle 450 to be branched into four fibers in the proximity of the terminal end IE and the terminal end OE, this is merely depicting the optical fiber bundle 450 to be branched in the figure in order to illustrate the interval between the four cores, and the optical fiber bundle to be used in practice may not have such branches depicted in FIG. 13 and may be configured as such a single linear structure body as depicted in FIG. 12.

At both the light entrance side terminal end IE and the light outgoing side terminal end OE of the bundle, the positional relation of the four optical fibers is fixed, and in other words, the arrangement of (interval between) the four optical fibers at the terminal ends is fixed. As depicted in FIG. 13, the multiple cores may be lined up linearly at the light incoming side terminal end IE. Also at the light outgoing side terminal end OE, the multiple cores may be lined up linearly.

Further, the distance between the cores of two certain optical fibers described hereinabove may be, for example, in regard to the cores CI1 and CI2 at the light incoming side terminal end in FIG. 13, a linear distance between the cores CI1 and CI2 and a distance indicated by an arrow mark Lci in FIG. 13. This similarly applies to the distance between the other two cores.

Meanwhile, for example, as regards the cores CO1 and CO2 at the light entrance side terminal end in FIG. 13, the interval may be a linear distance between the cores CO1 and CO2 and is a distance indicated by an arrow mark Lco in FIG. 13. This similarly applies to the interval between the other two cores.

Further, the distance Lci and the distance Lco may not necessarily be an equal distance. In other words, the distances may be adjusted suitably in line with the optical magnification between the entrance side and the outgoing side.

As described above, the flow cytometer according to an embodiment of the present disclosure may include an optical fiber bundle. At the opposite terminal ends (light entrance side terminal end and light outgoing side terminal end) of the optical fiber bundle, the arrangement of the cores of the multiple optical fibers included in the optical fiber bundle may be fixed, and particularly, the arrangement interval between the cores of the multiple optical fibers may be fixed.

It is to be noted that, although the number of cores is three and four in FIGS. 12 and 13, respectively, it is apparent that the number of cores is not restricted to them. For example, the number of cores may be equal to the number of light irradiation positions (or the number of light detector arrays in the optical detection apparatus) and may be, for example, two or more.

Further, in a certain embodiment, the number of cores may be smaller than the number of light irradiation positions (or the number of light detector arrays in the optical detection apparatus). In this case, at least one optical fiber may be shared as an optical path by light generated by light application at two or more light irradiation positions.

Further, in another embodiment, the number of cores may be greater than the number of light irradiation positions (or the number of light detector arrays in the optical detection apparatus). In this case, an optical fiber to be used as a propagation optical path for light generated by light application to a bioparticle may be switched suitably.

Further, although FIG. 12 depicts an example of a flow cytometer in which an optical fiber bundle is used, an optical fiber or fibers that are not bundled may be used in place of the optical fiber bundle. For example, as described hereinabove, the optical fiber may be an optical fiber having multiple core-clad sets or may be an optical fiber in which multiple cores are provided in one clad as hereinafter described.

Also in a case where such an optical fiber as described above is used, the multiple optical fiber cores included in the optical fiber may be arranged in such a manner as to correspond to the intervals between the multiple light irradiation positions on the flow path at the light entrance side terminal end as described hereinabove. Further, as described hereinabove, the multiple optical fiber cores included in the optical fiber may be arranged in such a manner as to correspond to the intervals between the light detector arrays at the light outgoing side terminal end.

An example of a configuration of an optical fiber that can be used in an embodiment of the present disclosure is described below with reference to the drawings. As the optical fiber that forms the propagation optical path, one of an optical fiber bundle and optical fibers described in the following examples 1 to 3 may be used or two or more of them may be used in combination.

### (Example 1: Optical Fiber Bundle)

FIG. 19A is a schematic transverse sectional view of an example of the optical fiber bundle. FIG. 19A is a schematic view of a substantially perpendicular section with respect to the advancing direction of light, and components depicted do not reflect actual sizes of them.

An optical fiber bundle 700 depicted in FIG. 19A is a bundle having three optical fibers 701. Each optical fiber 701 has a set of a core 703, a clad 704 surrounding the core, and a covering layer 704 surrounding the clad. In particular, the core, the clad, and the covering layer are layered concentrically. The materials of the core, the clad, and the covering layer may all be known materials used in the relevant technical field.

As depicted in FIG. 19A, in the optical fiber bundle 700, the three optical fibers 701 are arranged in such a manner as to appear in a lined up relation in a row in the transverse section described above, and the arrangement is fixed by a fixing member 702. It is to be noted that the arrangement may not be fixed and, for example, may not be fixed midway of the bundle (that is, in an intermediate region of the bundle other than the light entrance side terminal end and the light outgoing side terminal end). The fixing member 702 may include a known material used in the relevant technical field such as resin, rubber, or fiber, for example.

Further, although the optical fiber bundle 700 depicted in FIG. 19A includes three optical fibers, the number of optical fibers included in the bundle is not restricted to three and may be two or more, three or more, or four or more and may be, for example, a number corresponding to the number of light detector arrays or more. Moreover, although, in FIG. 19A, the bundle is configured such that the three optical fibers appear in a lined up relation in a row in a cross section of the optical fiber bundle, the arrangement of optical fibers is not restricted to this. For example, a greater number of optical fibers may be bundled as in an optical fiber bundle 800 depicted in FIG. 19B.

In other words, the optical fibers may not necessarily be arranged in such a manner as to form only one row as in FIG. 19A.

### (Example 2: Optical Fiber Having Multiple Core-Clad Sets)

FIG. 19C is a schematic transverse sectional view of an example of one optical fiber. An optical fiber 710 depicted in FIG. 19C includes three core-clad sets 711. Each core-clad set signifies a set of a core 713 and a clad 714 surrounding the core (that is, a structure body including the two elements). Further, a covering layer 712 is provided in such a manner as to surround the three core-clad sets. The materials of the core, the clad, and the covering layer may all be known materials that are used in the relevant technical field.

In the optical fiber 710 depicted in FIG. 19C, the three core-clad sets 711 are arranged in such a manner as to appear in a lined up relation in a row in the transverse section, and the arrangement is fixed by the covering layer 712. It is to be noted that the arrangement may not be fixed and, for example, may not be fixed midway of the bundle (that is, in an intermediate region between the light entrance side terminal end and the light outgoing side terminal end of the bundle).

Further, although the optical fiber 710 depicted in FIG. 19C includes the three core-clad sets 711, the number of core-clad sets included in the optical fiber is not restricted to three and may be two or more, three or more, or four or more and may be, for example, a number corresponding to the number of the light detector arrays or more.

Moreover, although, in FIG. 19C, the optical fiber is configured such that the three core-clad sets appear in a lined up relation in a row in a cross section of the optical fiber, the arrangement of core-clad sets is not restricted to this. For example, multiple core-clad sets may be bundled as in an optical fiber bundle 810 depicted in FIG. 19D, and in other words, the core-clad sets may not necessarily be arranged in such a manner as to form only one row as depicted in FIG. 19C.

FIG. 19E is a schematic transverse sectional view of another example of one optical fiber. An optical fiber 720 depicted in FIG. 19E is the same as the optical fiber 710 depicted in FIG. 19C except that the positions of the three core-clad sets 711 are fixed by a fixation material (for example, resin or the like) 715. In an embodiment of the present disclosure, an optical fiber in which the arrangement of the multiple core-clad sets 711 is fixed by a fixation material in such a manner may be used. Around the fixation material, a covering layer may be present as in FIG. 19C. The fixation material may be a known material that is used in the relevant technical field.

Further, although the optical fiber 720 depicted in FIG. 19E includes three core-clad sets 711, the number of core-clad sets included in the optical fiber is not restricted to three and may be two or more, three or more, or four or more and, for example, may be a number corresponding to the number of light detector arrays or more. Moreover, although, in FIG. 19E, the optical fiber is configured such that the three core-clad sets appear in a lined up relation in a row in a cross section of the optical fiber, the arrangement of the core-clad sets is not restricted to this. For example, multiple optical fibers may be bundled as in an optical fiber bundle 820 depicted in FIG. 19F, and the optical fibers may not necessarily be arranged in such a manner as to form only one row as in FIG. 19E.

In one embodiment, the fixation by a fixation material depicted in FIG. 19E may be performed, for example, only at the light outgoing end and/or the light entrance end of the optical fiber, and the optical fiber may not be fixed in an intermediate region thereof. In particular, the optical fiber is fixed at the light outgoing end and/or the light entrance end by a fixation material as depicted in FIG. 19E or 19F, and in an intermediate region of the optical fiber, fixation by a fixation material may not be performed as indicated in FIG. 19C or 19D.

In another embodiment, the fixation by a fixation material depicted in FIG. 19E may be performed over an overall optical fiber area including the light outgoing end and/or the light entrance end of the optical fiber.

### (Example 3: Optical Fiber in Which Multiple Cores are Provided in Clad)

FIG. 19G is a schematic transverse sectional view of another example of one optical fiber. An optical fiber 730 depicted in FIG. 19G includes three cores 733. The three cores 733 exist in one clad 734. Further, a covering layer 732 is provided in such a manner as to surround the clad. The materials of the core, the clad, and the covering layer may all be known materials used in the relevant technical field.

In the optical fiber 730 depicted in FIG. 19G, the three cores 733 are lined up in a row, and this arrangement is fixed by the clad 734.

Although the optical fiber 730 depicted in FIG. 19G includes the three cores 733, the number of cores included in the optical fiber is not restricted to three and may be two or more, three or more, or four or more and, for example, may be equal to a number corresponding to the number of light detector arrays or more. Further, although the optical fiber in FIG. 19G is configured such that the three cores appear in a lined up relation in a row, the arrangement of the cores is not restricted to this. For example, multiple cores may exist in a clad as in an optical fiber 830 depicted in FIG. 19H, and in other words, they may not necessarily be arranged in such a manner to form only one row as in FIG. 19G.

### (6) Design of Optical Path by Spectral Optical System

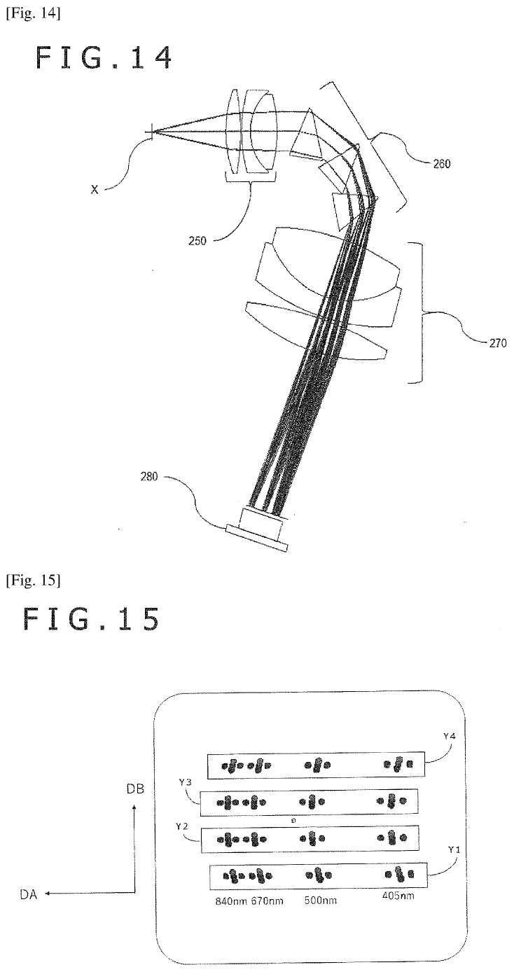

An example of design of an optical path for light to the optical detection apparatus by the spectral optical system in the flow cytometer according to the present disclosure is described with reference to FIG. 14.

FIG. 14 is a schematic view of optical paths for light to the optical detection apparatus designed by the spectral optical system. For example, in the example of the configuration of the flow cytometer depicted in FIG. 2, the optical paths can be applied as optical paths from the field diaphragm 240 to the light detectors 280. Further, in the example of the configuration of the flow cytometer depicted in FIG. 12, the optical paths can be applied as optical paths from the light outgoing side terminal end of the optical fiber bundle 440 to the optical detection apparatus 280.

Light entering from the field diaphragm 240, the light outgoing side terminal end of the optical fiber bundle 440, or the like to an entrance end X of light depicted in FIG. 14 passes the detector side light guide optical system 250, by which the advancing direction thereof is adjusted to any direction such as a parallel direction. An optical part that can be used as the detector side light guide optical system described in the present specification can be used suitably as an optical part that configures the detector side light guide optical system 250. While FIG. 14 depicts an example in which an optical system including two lenses is used, this is not restrictive, and a person skilled in the art may design freely according to an object of the optical part.

The light whose route has been adjusted to a desired direction by the detector side light guide optical system 250 is spectralized for each wavelength by the spectral optical system 260. An optical part that can be used as the spectral optical system described in the present specification can be used suitably as an optical part that configures the spectral optical system 260. Although FIG. 14 depicts an example in which three prisms designed with the vertical angle of 40 degrees are used, this is not restrictive, and a person skilled in the art may design freely according to an object of the optical part.

Light spectralized by the spectral optical system 260 arrives at the telecentric condensing lens 270. The telecentric condensing lens 270 arranges the advancing direction of the spectralized light to any direction such as a parallel direction and causes the light to arrive at the optical detection apparatus 280. For an optical part configuring the telecentric condensing lens 270, an optical part that can be used as the telecentric condensing lens described in the present specification can be used suitably. Although FIG. 14 depicts an example in which an optical system including two lenses is used, this is not restrictive, and a person skilled in the art may freely design according to an object of the optical part.

In the example depicted in FIG. 14, light generated by light irradiation to bioparticles flowing in a flow path at multiple light irradiation positions arrives at the optical detection apparatus 280 through the same detector side light guide optical system 250, spectral optical system 260, and telecentric condensing lens 270. In particular, the flow cytometer according to the present disclosure can be designed as a form in which the number of detector side light guide optical system 250, spectral optical system 260, and telecentric condensing lens 270 is smaller than the number of light irradiation positions.

FIG. 15 depicts an entrance surface, for example, in a case where light having passed through the optical path for light to the optical detection apparatus indicated in the example of FIG. 14 or the like enters the optical detection apparatus.

In a case where light generated by light irradiation at multiple light irradiation positions on bioparticles flowing in a flow path is imaged on the entrance surface of the optical detection apparatus after being spectralized by the spectral optical system, the positions on the entrance surface at which the spectra of light corresponding to the light irradiation positions are outputted can possibly be displaced due to an aberration by an optical part or the like.

Further, rays of light configuring spectra outputted to the entrance surface by the spectralization described above have, for individual wavelengths, widths that differ depending upon the wavelength when they are outputted. Typically, light of a short wavelength at the time of being outputted has a great width while light of a long wavelength at the time of being outputted has a small width. Therefore, the light amount per area with which light of a short wavelength is outputted to the entrance surface is relatively small in comparison with that with which light of a long wavelength is outputted to the entrance surface.

In the example depicted in FIG. 15, four spectra Y1 to Y4 of light are outputted to the entrance surface of the optical detection apparatus in a corresponding relation with four light irradiation positions. In FIG. 15, it can be confirmed that the positions at which the four spectra Y1 to Y4 of light are outputted are displaced along an array direction DA of an array arranged in line with the output positions of the spectra. Together with this, it can also be confirmed that the positions at which rays of light having the same wavelength are outputted are displaced along the array direction DA.

Further, in FIG. 15, it can be confirmed that, in regard to rays of light configuring the spectra Y1 to Y4, the width with which light of a short wavelength is outputted is great while the width with which light of a long wavelength is outputted is small.

The amount and the direction with and in which the positions on the entrance surface at which the spectra of rays of light corresponding to the light irradiation positions are outputted are displaced depend upon the detector side light guide optical system 250, the spectral optical system 260, and the telecentric condensing lens 270 that are used in the flow cytometer, a combination of them, or arrangement of the components and optical paths that pass through the optical parts. Conversely, it is also possible to adjust the arrangement of the optical parts or the optical paths according to positions at which the spectra are to be outputted. For example, while FIG. 15 depicts an entrance surface in a case where light that has passed through the optical paths for light to the optical detection apparatus indicated by the example of FIG. 14 and so forth using a prism as the spectral optical system enters the optical detection apparatus, in a case where a diffraction grating is used in place of the prism as the spectral optical system, typically, the influence on displacement of the position at which a spectrum is outputted decreases from that in the case where the prism is used. Accordingly, adjusting the optical parts to be used and positions of them with characteristics of the optical parts to be used taken into consideration makes it possible to adjust the positions on the entrance surface at which the spectra are to be outputted.

Further, the width of light for each wavelength configuring a spectrum to be outputted depends upon the separation power of light of the spectral optical system to be used. Taking this into consideration, the area of the light receiving face of the light detector elements configuring the light detector array may be adjusted to the width of a ray of light for each wavelength to be outputted, or the sensitivity of the light detector elements may be adjusted according to the light amount of light for each wavelength to be outputted.

In the example depicted in FIG. 15, the spectra outputted to the entrance surface are outputted at predetermined intervals along an intersecting direction DB intersecting with the array direction DA. The intervals with which the spectra are outputted correspond to intervals of rays of light entering the light entrance end X depicted in FIG. 14. For example, in a case where rays of light enter the entrance end X at intervals corresponding to the intervals between the light irradiation positions for bioparticles flowing in the flow path, the intervals between the spectra of light outputted to the entrance surface are intervals corresponding to the intervals between the light irradiation positions.

Accordingly, it is also possible to adjust the interval between the spectra outputted to the entrance surface by the interval between the light irradiation positions for bioparticles flowing in the flow path, the arrangement position of the optical fiber cores at the light outgoing side terminal end of the optical bundle fibers, or the like.

Here, “corresponding intervals” are not limited to the same interval and include those in a case in which each interval is multiplied by a fixed multiplier.

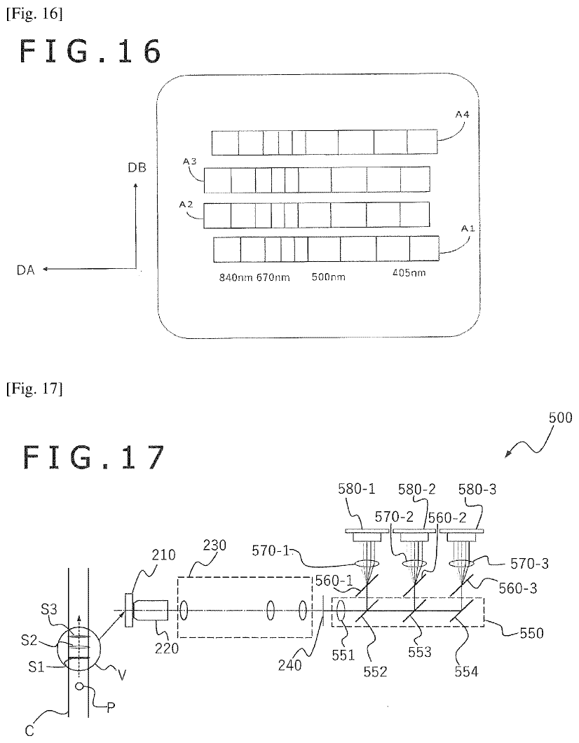

FIG. 16 is a schematic view depicting an example of an optical detection apparatus that includes multiple light detector arrays corresponding to positions of spectra of light outputted to the entrance surface of the optical detection apparatus illustrated by the example of FIG. 15.

In particular, four light detector arrays A1 to A4 included in the optical detection apparatus depicted in FIG. 16 are arranged in a manner corresponding to the positions to which the four spectra Y1 to Y4 of light illustrated in the example of FIG. 15 are outputted. It is to be noted that, while FIG. 16 depicts an example adapted to the example of entrance of light depicted in FIG. 15, this is not restrictive, and the number of light detector arrays or the arrangement of the light detector array can be adjusted according to the number of spectra outputted to the entrance surface of the optical detection apparatus or the positions at which the spectra are outputted. Conversely, the number of spectra to be outputted to the entrance surface of the optical detection apparatus or the positions at which the spectra are outputted may be adjusted according to the number of light detector arrays included in the optical detection apparatus or with the positions of the light detector arrays.

Further, FIG. 16 depicts an example of an optical detection apparatus that has light detector arrays including multiple light detector elements having light receiving faces whose areas are not equal to each other. In this case, adjusting the area of the light receiving faces of the light detector elements provided in the light detector array to areas according to the widths with which light of the individual wavelengths to be detected is outputted or the area according to the light amount makes it possible to suppress dispersion from occurring in the detection sensitivity of the light detector array corresponding to the wavelength of light. In addition to the configuration described above, for example, adjusting the area of the light receiving face of the light detector elements according to APD sensitivity for each wavelength region of the light detector elements to be used also makes it possible to suppress dispersion from occurring in the detection sensitivity of the light detector array with respect to the wavelength of light.

As depicted in FIG. 16, the multiple light detector arrays included in the optical detection apparatus can avoid dispersion from occurring in detection sensitivity for each wavelength, by using a light detector array including a combination of the same light detector elements and arranging the light detector array in a manner corresponding to the positions of spectra of outputted light.

### (7) Other Examples of Configuration (Use of Multiple Optical Detection Apparatuses)

The flow cytometer depicted in FIG. 2 includes one optical detection apparatus. The number of optical detection apparatuses included in the flow cytometer according to an embodiment of the present disclosure is not restricted to one and may be two or more. In particular, in one embodiment of the present disclosure, the flow cytometer may include two or more optical detection apparatuses, and at least one of the two or more optical detection apparatuses may include multiple light detector arrays.

The flow cytometer including two or more optical detection apparatuses contributes to effective use of the light detector elements of the optical detection apparatus and contributes also to detection of light spectrally dispersed more finely. For example, in a case where fluorescence light generated by application of excitation light having a specific wavelength to a bioparticle is to be detected, in order to prevent detection of the excitation light, a notch filter for cutting the excitation light is sometimes provided on the optical path of a light guide optical system (for example, a detector side light guide optical system). The notch filter does not pass light having a wavelength proximate to that of the excitation light therethrough. Hence, although such an advantage that only fluorescence light is detected by the notch filter is obtained, the light detector element allocated to detect light having the wavelength of the excitation ray is not used effectively. Therefore, the flow cytometer may be configured such that multiple optical detection apparatuses are incorporated therein, and the optical detection apparatuses may be configured to detect rays of light within wavelength ranges different from each other.

This embodiment is described below with reference to FIG. 17.

A flow cytometer 500 depicted in FIG. 17 has a configuration that is the same as that of the flow cytometer depicted in FIG. 2 except that the detector side light guide optical system 250, the spectral optical system 260, the telecentric condensing lens 270, and the optical detection apparatus 280 are changed to a detector side light guide optical system 550 (551 to 554), a spectral optical system 560 (560-1 to 560-3), a telecentric condensing lens 570 (570-1 to 570-3), and an optical detection apparatus 580 (580-1 to 580-3).

The optical detection apparatuses 580-1, 580-2, and 580-3 each have multiple light detector arrays lined up at predetermined intervals along the flow direction as described in (1) above. The flow cytometer 500 is configured such that the three optical detection apparatuses individually detect rays of light within wavelength ranges different from each other.

As an example, there is assumed a case in which excitation light having a wavelength of 390 nm, excitation light having a wavelength of 540 nm, and excitation light having a wavelength of 690 nm are applied to a bioparticle at three irradiation positions and light having a wavelength ranging from 400 to 850 nm is detected.

In this case, it is assumed that the optical detection apparatuses are allocated such that the optical detection apparatus 580-1 detects light having a wavelength ranging from 400 to 530 nm; the optical detection apparatus 580-2 detects light having a wavelength ranging from 550 to 680 nm; and the optical detection apparatus 580-3 detects light having a wavelength ranging from 700 to 850 nm. Further, light of 530 to 550 nm and light of 680 to 700 nm are cut by the notch filter.

Light having passed through the field diaphragm 240 is split into three rays of light within the wavelength ranges described above by the detector side light guide optical system 550. Although the light guide optical system 550 may be configured, for example, in such a manner as described below, the configuration of it may be changed suitably, for example, in accordance with the number of optical detection apparatuses, the wavelength range to be detected by each optical detection apparatus, and so forth.

The light having passed through the field diaphragm 240 passes a lens 551 (for example, a collimator lens or the like) and arrives at a dichroic mirror 552.

The dichroic mirror 552 has such an optical characteristic of reflecting light having a wavelength of 550 nm or less and passing light having a wavelength longer than 550 nm. Consequently, fluorescence light having a wavelength of 550 nm or less arrives at a spectral optical system 560-1 (transmission type diffraction grating in FIG. 14).

The light having passed through the dichroic mirror 552 (that is, light having a wavelength longer than 550 nm) arrives at a dichroic mirror 553. The dichroic mirror 553 has such an optical characteristic of reflecting light having a wavelength of 700 nm or less and passing therethrough light having a wavelength longer than 700 nm. Consequently, fluorescence light having a wavelength longer than 550 nm but equal to or shorter than 700 nm arrives at a spectral optical system 560-2 (transmission type diffraction grating).

The light having passed through the dichroic mirror 553 (that is, light having a wavelength longer than 700 nm) arrives at the mirror 554. The mirror 554 has such an optical characteristic of reflecting light having a wavelength of 850 nm or less. Consequently, fluorescence light having a wavelength longer than 700 nm but equal to or shorter than 850 nm arrives at a spectral optical system 560-3 (transmission type diffraction grating).

It is to be noted that the detector side light guide optical system 550 may further include one or more notch filters (not depicted) that cut excitation light. The one or more notch filters may be arranged suitably on the optical path of the optical system.

The spectral optical system 560-1 spectrally disperses the light arriving thereat and having a wavelength ranging from 400 to 550 nm. The spectrally dispersed rays of light are parallelized by the telecentric condensing lens 570-1 and arrive at the optical detection apparatus 580-1. The optical detection apparatus 580-1 includes multiple light detector arrays. Each of the light detector arrays includes light detector elements lined up in a row. The light detector arrays are allocated in such a manner as to detect light of 400 to 550 nm. More specifically, the light detector element at one end of the array is allocated in such a manner as to detect light having a wavelength of approximately 400 nm, and the light detector element of multiple ends of the array is allocated in such a manner as to detect light having the wavelength of 550 nm. The light detector elements present between the opposite ends detect spectrally dispersed rays of light having wavelengths ranging from 400 nm to 550 nm.

The spectral optical system 560-2 spectrally disperses the light arriving thereat and having a wavelength ranging from 550 to 700 nm. The spectrally dispersed rays of light are parallelized by the telecentric condensing lens 570-2 and arrive at the optical detection apparatus 580-2. The optical detection apparatus 580-2 includes multiple light detector arrays. Each of the light detector arrays includes light detector elements lined up in a row. The light detector arrays are allocated in such a manner as to detect light of 550 to 700 nm. More specifically, the light detector element at one end of the array is allocated in such a manner as to detect light having a wavelength of approximately 550 nm, and the light detector element of multiple ends of the array is allocated in such a manner as to detect light having a wavelength of 700 nm. The light detector elements present between the opposite ends detect spectrally dispersed rays of light having wavelengths ranging from 550 to 700 nm.

The spectral optical system 560-3 spectrally disperses the light arriving thereat and having a wavelength ranging from 700 to 850 nm. The spectrally dispersed rays of light are parallelized by the telecentric condensing lens 570-3 and arrive at the optical detection apparatus 580-3. The optical detection apparatus 580-3 includes multiple light detector arrays. Each of the light detector arrays includes light detector elements lined up in a row. The light detector arrays are allocated in such a manner as to detect light of 700 to 850 nm. More specifically, the light detector element at one end of the array is allocated in such a manner as to detect light having a wavelength of approximately 700 nm, and the light detector element of multiple ends of the array is allocated in such a manner as to detect light having a wavelength of 850 nm. The light detector elements present between the opposite ends detect spectrally dispersed rays of light having wavelengths ranging from 700 to 850 nm.

As described above, the detector side light guide optical system 550 splits light into rays of light of multiple wavelength ranges such that they individually arrive at the multiple optical detection apparatuses. The multiple optical detection apparatuses are configured such that the light detector arrays thereof individually detect rays of light arriving thereat and having wavelengths within the respective wavelength ranges, with use of the overall area of the arrays. Consequently, the light detector arrays are used effectively. In addition, more detailed analysis can be implemented.

### (8) Embodiment Including No Objective Lens

In a general flow cytometer, an objective lens through which light generated by light application to a bioparticle flowing in a flow path passes is provided. The objective lens is provided in the proximity of the flow path and is provided very near, for example, to a flow cell or a cuvette.

In several embodiments, the flow cytometer according to an embodiment of the present disclosure may not include the objective lens. In this embodiment, the optical detection apparatus may be arranged on the flow path, and, in other words, light generated by the light application may be detected by the optical detection apparatus without intervention of any objective lens. Further, in the flow cytometer configured in such a manner, image data of a bioparticle may be acquired by the optical detection apparatus.

### (9) Example of Configuration of Flow Cytometer

The flow cytometer according to an embodiment of the present disclosure may include a light irradiation section, a detection section, and an information processing section. Further, the flow cytometer according to an embodiment of the present disclosure may further include a preparative isolation section. The light irradiation section, the detection section, the information processing section, and the preparative isolation section may be configured in such a manner as described below in relation to a biological sample analysis apparatus. The optical detection apparatus according to an embodiment of the present disclosure may be incorporated as a component of the detection section in the flow cytometer.

Further, a bioparticle to be irradiated with light by the flow cytometer according to an embodiment of the present disclosure may be prepared as a biological sample described below. Further, the flow path in which the bioparticle is to flow may be configured in such a manner as described below in relation to the biological sample analysis apparatus.

Further, the flow cytometer according to an embodiment of the present disclosure may be configured not only as a flow cytometer that performs only analysis of a bioparticle but also as a flow cytometer (referred to also as a cell sorter) that preparatively isolates a predetermined bioparticle in reference to an analysis result. The cell sorter may be configured to perform a preparative isolation process in an open space or may be configured to perform a preparative isolation process in a closed space.

It is to be noted that, in a case where there is a difference between the contents described in (1) to (8) above and the contents described in the present (9), the contents described in (1) to (8) described above are prioritized.

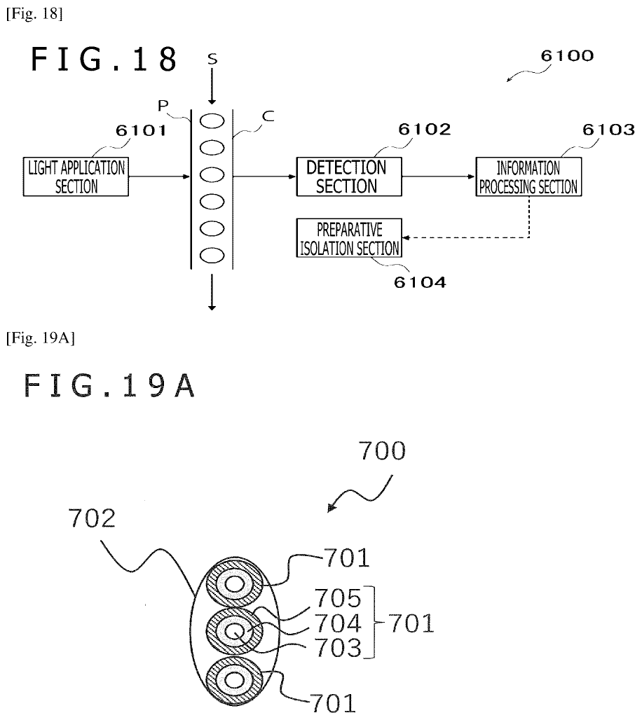

An example of a configuration of the biological sample analysis apparatus according to an embodiment of the present disclosure is depicted in FIG. 18. A biological sample analysis apparatus 6100 depicted in FIG. 18 includes a light irradiation section 6101 that irradiates a biological sample S flowing in a flow path C with light, a detection section 6102 that detects light generated by the application of light to the biological sample S, and an information processing section 6103 that processes information relating to the light detected by the detection section. As an example of the biological sample analysis apparatus 6100, a flow cytometer and an imaging cytometer can be mentioned. The biological sample analysis apparatus 6100 may include a preparative isolation section 6104 that performs preparative isolation of a specific bioparticle P in a biological sample. As an example of the biological sample analysis apparatus 6100 including the preparative isolation section, a cell sorter can be mentioned.

### (Biological Sample)

The biological sample S may be a liquid sample including a bioparticle. The bioparticle is, for example, a cellular or non-cellular bioparticle. The cell may be a living cell, and, as a more specific example, a blood cell such as a red blood cell or a white blood cell and a germ cell such as a sperm cell or a fertilized ovum can be mentioned. Further, the cell may be one directly sampled from a whole blood sample or may be a cultured cell acquired after culture. As the non-cellular bioparticle, an extracellular vesicle, particularly, an exosome, a micro-vesicle, and so forth, can be mentioned. The bioparticle may be labeled by one or multiple labeling substances (for example, a pigment (particularly, a fluorescent dye), a fluorescent dye labeling antibody, or the like). It is to be noted that, by the biological sample analysis apparatus according to an embodiment of the present disclosure, a particle other than a bioparticle may be analyzed, and a bead or the like may be analyzed for calibration or the like.

### (Flow Path)

The flow path C is configured such that a biological sample S flows therein. Particularly, the flow path C can be configured such that a flow is formed in which bioparticles included in the biological sample are lined up substantially in a row. A flow path structure including the flow path C may be designed such that a laminar flow is formed. Especially, the flow path structure is designed such that a laminar flow in which a flow of biological samples (sample flow) is wrapped by a flow of sheath liquid is formed. The design of the flow path structure may be selected suitably by a person skilled in the art, and a known flow path structure may be adopted. The flow path C may be formed in a flow path structure body (flow channel structure) such as a microchip (a chip including a flow path of the micrometer order), a flow cell, or the like. The width of the flow path C is equal to or smaller than 1 mm and particularly may be equal to or greater than 10 μm but equal to or smaller than 1 mm. The flow path C and the flow path structure body including the flow path C may include such a material as plastic or glass.

The biological sample analysis apparatus according to an embodiment of the present disclosure is configured such that a biological sample flowing in the flow path C, particularly, a bioparticle in the biological sample, is irradiated with light from the light irradiation section 6101. The biological sample analysis apparatus according to an embodiment of the present disclosure may be configured such that an irradiation point (interrogation point) of light with respect to the biological sample is present in the flow path structure body in which the flow path C is formed, or may be configured such that the irradiation point of the light is present outside the flow path structure body. As an example of the former configuration, there can be mentioned a configuration in which the flow path C in a microchip or a flow cell is irradiated with the light. In the latter configuration, a bioparticle that has gone out from the flow path structure body (particularly, a nozzle portion of the same) is irradiated with the light, and, for example, a flow cytometer of the Jet in Air type can be mentioned.

### (Light Irradiation Section)

The light irradiation section 6101 includes a light source section that emits light and a light guide optical system that guides the light to an irradiation point. The light source section includes one or multiple light sources. The type of the light source is, for example, a laser light source or a light emitting diode (LED). The wavelength of the light emitted from each of the light sources may be a wavelength of ultraviolet light, visible light, or infrared light. The light guide optical system includes optical parts such as a beam splitter group, a mirror group, or an optical fiber, for example.

Further, the light guide optical system may include a lens group for condensing light and includes, for example, an objective lens. The number of irradiation points at which a biological sample and light cross with each other may be one or a plural number. The light irradiation section 6101 may be configured such that rays of light emitted from one or multiple light sources different from each other are condensed to one irradiation point.

### (Detection Section)

The detection section 6102 includes at least one light detector that detects light generated by light application to a bioparticle. The light to be detected is, for example, fluorescence or scattered light (for example, one or more of forward scattered light, back-scattered light, and side scattered light). Each of the light detectors includes one or more light receiving elements and includes, for example, a light receiving element array. Each of the light detectors may include one or multiple PMTs (photomultiplier tubes) and/or a photodiode such as an APD or an MPPC. The light detector includes a PMT array in which, for example, multiple PMTs are arrayed in a one-dimensional direction. Further, the detection section 6102 may include an imaging element of a CCD, a CMOS, or the like. The detection section 6102 can acquire an image of a bioparticle (for example, a bright field image, a dark field image, a fluorescence image, or the like) by the imaging element.

The detection section 6102 includes a detection optical system that allows light of a predetermined detection wavelength to arrive at a corresponding light detector. The detection optical system includes a spectral dispersion section such as a prism or a diffraction grating or a wavelength separation section such as a dichroic mirror or an optical filter. The detection optical system is configured to, for example, spectrally disperse light generated by light application to a bioparticle, such that the spectrally dispersed rays of light are detected by multiple light detectors the number of which is greater than the number of fluorescence pigments with which the bioparticle is to be labeled. A flow cytometer including such a detection optical system as just described is called a spectrum type flow cytometer. Further, the detection optical system is configured to separate, for example, from light generated by light application to a bioparticle, light corresponding to a fluorescence wavelength range of a specific fluorescence pigment and cause the corresponding light detector to detect the separated light.

Further, the detection section 6102 can include a signal processing section that converts an electric signal obtained by the light detector into a digital signal. The signal processing section may include an analog/digital (A/D) converter as a device for performing the conversion. The digital signal obtained by conversion by the signal processing section can be transmitted to the information processing section 6103. The digital signal can be treated as data relating to light (hereinafter also referred to as “optical data”) by the information processing section 6103. The optical data may be, for example, optical data including fluorescence data. More particularly, the optical data may be light intensity data, and the light intensity may be light intensity data (may include a feature amount such as Area, Height, or Width) of light including fluorescence light.

### (Information Processing Section)

The information processing section 6103 includes, for example, a processing section that executes processing of various kinds of data (for example, optical data) and a storage section that stores various kinds of data therein. In a case where optical data corresponding to a fluorescence pigment is acquired from the detection section 6102, the processing section can perform fluorescence leakage correction (compensation process) for the light intensity data. Further, in the case of a spectrum type flow cytometer, the processing section executes a fluorescence separation process for the optical data and acquires light intensity data corresponding to the fluorescence pigment. The fluorescence separation process may be performed, for example, according to the unmixing method disclosed in Japanese Patent Laid-Open No. 2011-232259. In a case where the detection section 6102 includes an imaging element, the processing section may acquire form information of a bioparticle in reference to an image acquired by the imaging element. The storage section may be configured to be capable of storing the acquired optical data therein. The storage section may be further configured to be capable of storing spectral reference data to be used in the unmixing process described hereinabove therein.

In a case where the biological sample analysis apparatus 6100 includes the preparative isolation section 6104 hereinafter described, the information processing section 6103 can make a determination as to whether or not a bioparticle is to be preparatively isolated, in reference to the optical data and/or the form information. Then, the information processing section 6103 controls the preparative isolation section 6104 in reference to a result of the determination, and preparative isolation of the bioparticle by the preparative isolation section 6104 can be performed.

The information processing section 6103 may be configured to be capable of outputting various kinds of data (for example, optical data and an image). For example, the information processing section 6103 can output various kinds of data (for example, a two-dimensional plot, a spectral plot, and so forth) generated in reference to the optical data. Further, the information processing section 6103 may be configured to be capable of accepting an input of various kinds of data, and accepts, for example, a gating process on the plot by the user. The information processing section 6103 can include an outputting section (for example, a display unit or the like) or an inputting section (for example, a keyboard or the like) for executing the outputting or the inputting.

The information processing section 6103 may be configured as a general-purpose computer and may be configured, for example, as an information processing apparatus including a central processing unit (CPU), a random access memory (RAM), and a read only memory (ROM). The information processing section 6103 may be included in a housing in which the light application section 6101 and the detection section 6102 are provided or may be provided outside the housing. Further, various processes or functions to be implemented by the information processing section 6103 may be implemented by a server computer or a cloud connected through a network.

### (Preparative Isolation Section)

The preparative isolation section 6104 executes preparative isolation of a bioparticle in response to a result of determination made by the information processing section 6103. The method of preparative isolation may be a method of generating droplets including bioparticles by vibration, applying electric charge to a droplet of a preparative isolation target, and then controlling the advancing direction of the droplet with an electrode. The method of preparative isolation may be a method of controlling the advancing direction of the bioparticle to perform preparative isolation in the flow path structure body. In the flow path structure body, for example, a controlling mechanism by pressure (injection or suction) or by electric charge is provided. As an example of the flow path structure body, there can be mentioned a chip which has a flow path structure in which the flow path C is branched to a recovery flow path and a waste liquid flow path on the downstream side thereof and specific bioparticles are recovered to the recovery flow path (for example, the chip disclosed in Japanese Patent Laid-Open No. 2020-76736).

### 2. Second Embodiment (Biological Sample Analysis System)

The optical detection apparatus described above may be used not only in a flow cytometer but also in an analysis system other than the flow cytometer. In particular, one embodiment of the present disclosure provides also a biological sample analysis system including the optical detection apparatus described in 1. above.

In one embodiment, the biological sample analysis system may include an optical detection apparatus configured to detect light generated by light application to a bioparticle flowing in a flow path. As described in 1. above, the optical detection apparatus includes multiple light detector arrays in each of which light detector elements are lined up in a row, and the multiple light detector arrays may be arranged at predetermined intervals along a direction intersecting with an arraying direction of the light detector arrays.

As described in 1. above, the biological sample analysis system may include a light irradiation section, a detection section, and an information processing section. Further, the system may include a preparative isolation section. In the biological sample analysis system, the light irradiation section, the detection section, and the information processing section (and the preparative isolation section, optionally) may be incorporated in one apparatus or may be incorporated in a dispersed relation in multiple apparatuses.

Further, a bioparticle to be irradiated with light may not necessarily flow in a flow path. In particular, the bioparticle to be irradiated with light may be present in a region other than the flow path and may be, for example, a bioparticle present in a sample that is not flowing. Further, the target to be irradiated with light may be a particle other than a bioparticle or may be a biological substance other than a particle. The optical detection apparatus may be utilized, for example, in a microscope system, a biological substance system (for example, an analysis system for nucleic acid or protein or the like), a biological substance amplification system (for example, a nucleic acid amplification system or the like), and so forth.

In particular, one embodiment of the present disclosure provides also a biological sample analysis system that includes an optical detection apparatus configured to detect light generated by light application to a biological sample.

### 3. Third Embodiment (Optical Detection Apparatus)

One embodiment of the present disclosure provides also the optical detection apparatus described in 1. above. The optical detection apparatus is suitable for analysis of a bioparticle. For example, the optical detection apparatus may be used to detect light generated by light application to a bioparticle.

In one embodiment, the optical detection apparatus may be used in combination with a light irradiation section that irradiates the bioparticle with light at multiple light irradiation positions along the flow direction of the flow path. In particular, one embodiment of the present disclosure provides also a combination of the light irradiation section and the optical detection apparatus. The light irradiation section is as such described in 1. above.

Further, the optical detection apparatus may be used in combination with a spectral optical system that spectrally disperses multiple rays of light generated by light application at the multiple light irradiation positions. In particular, one embodiment of the present disclosure provides also a combination of the spectral optical system and the optical detection apparatus. The spectral optical system is as such described in 1. above.

In the spectral optical system, two or more light detector arrays among the multiple light detector arrays may have detection wavelength ranges same as each other.

It is to be noted that it is apparent to those skilled in the art that the shapes and the numbers of the various optical elements (for example, light guide optical systems, spectral optical systems, telecentric condensing lenses, and so forth) depicted in the ac-companying drawings of the present specification are schematic examples and the configuration (shape, number, and so forth) of them is not restricted to those depicted in the drawings. A person skilled in the art can suitably design each optical element such that it exhibits a function demanded for the optical element. For example, one lens depicted in the figures is not restricted to a single lens and may be configured as one lens system and, in other words, may be an aggregate of two or more lenses.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

It should be understood by those skilled in the art that various modifications, combinations, sub-combinations and alterations may occur depending on design requirements and other factors insofar as they are within the scope of the appended claims or the equivalents thereof.

Further, the present also provides the following.
<1>
A flow cytometer including:
an optical detection component that detects emission light emitted by a particle flowing in a flow path generated by application of excitation light to the particle flowing in the flow path, wherein
the optical detection component comprises multiple light detector arrays in each of which light detector elements are lined up in a respective row, and
the multiple light detector arrays are arranged at predetermined intervals along a direction intersecting with an arraying direction substantially parallel to the respective rows of the light detector elements of each of the light detector arrays.
<2>
The flow cytometer according to <1>, in which
an arrangement of the multiple light detector arrays corresponds to a flow direction of the flow path.
<3>
The flow cytometer according to <1>or <2>, in which wherein each of the multiple light detector elements is one of a photomultiplier tube element or an avalanche photodiode element.
<4>
The flow cytometer according to <1>or <2>, in which
each of the light detector elements is one of a photomultiplier tube element comprising a dynode including a semiconductor element or a photomultiplier tube element comprising multiple stages of dynodes.
<5>
The flow cytometer according to <1>or <2>, in which the optical detection component includes a multi-pixel photon counter.
<6>
The flow cytometer according to any one of <1>through <5>, further including:
a light irradiation section that irradiates the particle flowing in the flow path with the excitation light at multiple light irradiation positions along a flow direction of the flow path.
<7>
The flow cytometer according to <6>, in which light irradiation section is configured to individually irradiate each of the multiple light irradiation positions with rays of light having wavelengths different from each other.
<8>
The flow cytometer according to <6>or <7>, in which the optical detection component is configured to detect emission light generated by application of the excitation light at two or more positions of the multiple light irradiation positions.
<9>
The flow cytometer according to any one of <1>through <8>, in which respective gains of the multiple light detector arrays are adjustable independently of each other.
<10>
The flow cytometer according to any one of <1>through <9>, in which respective gains of the light detector elements of the multiple light detector arrays are adjustable independently of each other.
<11>
The flow cytometer according to any one of <1>through <10>, in which one or more of the multiple light detector arrays are configured such that respective positions thereof are adjustable in the direction intersecting with the arraying direction independently of each other.
<12>
The flow cytometer according to any one of <1>through <11>, in which one or more of the multiple light detector arrays are configured such that respective positions thereof are adjustable in the arraying direction independently of each other.
<13>
The flow cytometer according to any one of <1>through <12>, in which the optical detection component further comprises a microlens array comprising a plurality of lenses, each of the plurality of lenses being disposed on a respective light detector element of the multiple detector arrays.
<14>
The flow cytometer according to any one of <1>through <13>, further including: an optical propagation path along which the emission light propagates to the optical detection component, wherein the optical propagation path comprises one or more optical fibers.

### <15>

The flow cytometer according to any one of <1>through <13>, further including: a light irradiation section that irradiates the particle flowing in the flow path with the excitation light at multiple light irradiation positions along a flow direction of the flow path; and
an optical propagation path along which the emission light propagates to the optical detection component, wherein
the optical propagation path comprises multiple optical fiber cores, and
the multiple optical fiber cores are arranged in such a manner as to correspond to intervals between the multiple light irradiation positions at light input ends of the multiple optical fiber cores.
<16>
The flow cytometer according to any one of <1>through <14>, further including: a light irradiation section that irradiates the particle flowing in the flow path with the excitation light at multiple light irradiation positions along a flow direction of the flow path; and
an optical propagation path along which the emission light propagates to the optical detection component, wherein
the optical propagation path comprises multiple optical fiber cores, and
the multiple optical fiber cores are arranged in such a manner as to correspond to intervals between respective ones of the multiple light detector arrays at light output ends of the multiple optical fiber cores.
<17>
The flow cytometer according to any one of <1>through <13>, further including: an optical propagation path along which the emission light propagates to the optical detection component, wherein
a field diaphragm is disposed in the optical propagation optical.
<18>
The flow cytometer according to any one of <1>through <17>, in which at least one of the multiple light detector arrays comprises 10 or more light detector elements.
<19>
The flow cytometer according to any one of <1>through <18>, in which at least some of the multiple light detector elements of the optical detection component are configured to detect light independently of each other in time.
<20>
A biological sample analysis system including:
an optical detection component that detects emission light emitted by a particle flowing in a flow path generated by application of excitation light to the particle flowing in the flow path; and
an information processing section for processing the emission light detected by the optical detection component, wherein
the optical detection component comprises multiple light detector arrays in each of which light detector elements are lined up in a respective row, and
the multiple light detector arrays are arranged at predetermined intervals along a direction intersecting with an arraying direction substantially parallel to the respective rows of the light detector elements of each of the light detector arrays.
<21>
An optical detection apparatus including:
multiple light detector arrays in each of which light detector elements are lined up in a respective row, wherein
the multiple light detector arrays are arranged at predetermined intervals along a direction intersecting with an arraying direction substantially parallel to the respective rows of the light detector elements of each of the light detector arrays, and the multiple light detector arrays are used to detect emission light emitted by a particle flowing in a flow path generated by application of excitation light to the particle flowing in the flow path.
<22>
The optical detection apparatus according to <21>, in which the optical detection component is configured to be used in combination with a light irradiation section that irradiates the particle with the excitation light at multiple light irradiation positions along a flow direction of the flow path.
<23>
The optical detection apparatus according to <21>or <22>, in which the optical detection component is configured to be used in combination with a spectral optical system that spectrally disperses multiple rays of the emission light generated by application of the excitation at the multiple light irradiation positions.
<24>
The optical detection apparatus according to any one of <21>through <23>, in which two or more light detector arrays of the multiple light detector arrays include at least one light detector element having a detection wavelength range that is same between the two or more light detector arrays.

### REFERENCE SIGNS LIST

200: Flow cytometer
210: Flow cell
220: Objective lens
230: Flow path side light guide optical system
240: Field diaphragm
250: Detector side light guide optical system
260: Spectral optical system
270: Telecentric condensing lens
280: Optical detection apparatus

1. A flow cytometer comprising:
an optical detection component that detects emission light emitted by a particle flowing in a flow path generated by application of excitation light to the particle flowing in the flow path, wherein
the optical detection component comprises multiple light detector arrays in each of which light detector elements are lined up in a respective row, and
the multiple light detector arrays are arranged at predetermined intervals along a direction intersecting with an arraying direction substantially parallel to the respective rows of the light detector elements of each of the light detector arrays.

2. The flow cytometer according to claim 1, wherein an arrangement of the multiple light detector arrays corresponds to a flow direction of the flow path.

3. The flow cytometer according to claim 1, wherein each of the multiple light detector elements is one of a photomultiplier tube element or an avalanche photodiode element.

4. The flow cytometer according to claim 1, wherein each of the light detector elements is one of a photomultiplier tube element comprising a dynode including a semiconductor element or a photomultiplier tube element comprising multiple stages of dynodes.

5. The flow cytometer according to claim 1, wherein the optical detection component comprises a multi-pixel photon counter.

6. The flow cytometer according to claim 1, further comprising:
a light irradiation section that irradiates the particle flowing in the flow path with the excitation light at multiple light irradiation positions along a flow direction of the flow path.

7. The flow cytometer according to claim 6, wherein the light irradiation section is configured to individually irradiate each of the multiple light irradiation positions with rays of light having wavelengths different from each other.

8. The flow cytometer according to claim 6, wherein the optical detection component is configured to detect emission light generated by application of the excitation light at two or more positions of the multiple light irradiation positions.

9. The flow cytometer according to claim 1, wherein respective gains of the multiple light detector arrays are adjustable independently of each other.

10. The flow cytometer according to claim 1, wherein respective gains of the light detector elements of the multiple light detector arrays are adjustable independently of each other.

11. The flow cytometer according to claim 1, wherein one or more of the multiple light detector arrays are configured such that respective positions thereof are adjustable in the direction intersecting with the arraying direction independently of each other.

12. The flow cytometer according to claim 1, wherein one or more of the multiple light detector arrays are configured such that respective positions thereof are adjustable in the arraying direction independently of each other.

13. The flow cytometer according to claim 1, wherein the optical detection component further comprises a microlens array comprising a plurality of lenses, each of the plurality of lenses being disposed on a respective light detector element of the multiple detector arrays.

14. The flow cytometer according to claim 1, further comprising an optical propagation path along which the emission light propagates to the optical detection component, wherein the optical propagation path comprises one or more optical fibers.

15. The flow cytometer according to claim 1, further comprising:
a light irradiation section that irradiates the particle flowing in the flow path with the excitation light at multiple light irradiation positions along a flow direction of the flow path; and
an optical propagation path along which the emission light propagates to the optical detection component, wherein
the optical propagation path comprises multiple optical fiber cores, and the multiple optical fiber cores are arranged in such a manner as to correspond to intervals between the multiple light irradiation positions at light input ends of the multiple optical fiber cores.

16. The flow cytometer according to claim 1, further comprising:
a light irradiation section that irradiates the particle flowing in the flow path with the excitation light at multiple light irradiation positions along a flow direction of the flow path; and
an optical propagation path along which the emission light propagates to the optical detection component, wherein
the optical propagation path comprises multiple optical fiber cores, and
the multiple optical fiber cores are arranged in such a manner as to correspond to intervals between respective ones of the multiple light detector arrays at light output ends of the multiple optical fiber cores.

17. The flow cytometer according to claim 1, further comprising:
an optical propagation path along which the emission light propagates to the optical detection component, wherein
a field diaphragm is disposed in the optical propagation optical.

18. The flow cytometer according to claim 1, wherein at least one of the multiple light detector arrays comprises 10 or more light detector elements.

19. The flow cytometer according to claim 1, wherein at least some of the multiple light detector elements of the optical detection component are configured to detect light independently of each other in time.

20. A biological sample analysis system comprising:
an optical detection component that detects emission light emitted by a particle flowing in a flow path generated by application of excitation light to the particle flowing in the flow path; and
an information processing section for processing the emission light detected by the optical detection component, wherein
the optical detection component comprises multiple light detector arrays in each of which light detector elements are lined up in a respective row, and
the multiple light detector arrays are arranged at predetermined intervals along a direction intersecting with an arraying direction substantially parallel to the respective rows of the light detector elements of each of the light detector arrays.

21. An optical detection component comprising:
multiple light detector arrays in each of which light detector elements are lined up in a respective row, wherein
the multiple light detector arrays are arranged at predetermined intervals along a direction intersecting with an arraying direction substantially parallel to the respective rows of the light detector elements of each of the light detector arrays, and the multiple light detector arrays are used to detect emission light emitted by a particle flowing in a flow path generated by application of excitation light to the particle flowing in the flow path.

22. The optical detection component according to claim 21, wherein the optical detection component is configured to be used in combination with a light irradiation section that irradiates the particle with the excitation light at multiple light irradiation positions along a flow direction of the flow path.

23. The optical detection component according to claim 22, wherein the optical detection component is configured to be used in combination with a spectral optical system that spectrally disperses multiple rays of the emission light generated by application of the excitation at the multiple light irradiation positions.

24. The optical detection component according to claim 21, wherein two or more light detector arrays of the multiple light detector arrays include at least one light detector element having a detection wavelength range that is same between the two or more light detector arrays.
